(19) United States
(12) Patent Application Publication
(10) Pub. No.: US 2002/0128866 A1
(43) Pub. Date: Sep. 12, 2002

(54) Chronic pain patient care plan

(76) Inventors: Gary A. Goetzke, St. Paul, MN (US); Tommy N.P. Johns, Minneapolis, MN (US); Malcolm E. Reid, St. Paul, MN (US); Angeline M. Carlson, Eden Prairie, MN (US)

Correspondence Address: Eric R. Waldkoetter, Medtronic, Inc., LC340, 710 Medtronic Parkway, Minneapolis, MN, 55432-5604, US

(21) Appl. No.: 09/844,144

(22) Filed: Apr. 27, 2001

Related U.S. Application Data
(60) Provisional application No. 60/258,556, filed on Dec. 29, 2000.

(51) Int. Cl. G06F 17/60

(52) U.S. Cl. 705/2

(57) ABSTRACT

The medical resource for chronic pain patients are forecasted using a method or computer software product to improve accuracy in forecasting medical resources, decrease the time required to forecast medical resources, and many other benefits. Desired patient indicia including direct medical indicia, indirect medical indicia, and non-medical indicia are selected to serve as independent variables. At least one chronic pain indication is selected to serve as a dependent variable. A chronic pain forecasting model is created using the patient indicia and the chronic pain indication. The chronic pain forecasting model is applied to a chronic pain patient indicia to create a patient forecast. Many different embodiments of the chronic pain patient identification system method and software product are possible.

### CROSS REFERENCE

This application claims the benefit of provisional application U.S. Serial No. 60/258,556 filed on Dec. 29, 2000 entitled “Disease Management System And Methods” by Goetzke et al. This application is also related to the following co-pending applications entitled “Chronic Pain Patient Identification System” by inventors Goetzke et al. (attorney docket number P9581.00); “Chronic Pain Patient Risk Stratification System” by inventors Goetzke et al. (attorney docket number P9640.00); “Chronic Pain Patient Diagnosis System” by inventors Goetzke et al. (attorney docket number P9641.00); “Chronic Pain Patient Medical Resources Forecaster” by inventors Goetzke et al. (attorney docket number P9642.00) which are not admitted as prior art with respect to the present invention by its mention in this cross reference section.

### BACKGROUND OF THE INVENTION

This disclosure relates to a medical information system and more specifically to a chronic pain patient care plan computer program and method.

Although medical treatment of acute injuries and illnesses have improved significantly over the past few decades, chronic disease remains by far the greatest cause of mortality, diminished quality of life, and increased healthcare expenditures. Approximately 80% of healthcare costs are spent on the treatment of chronic disease, much of it on unnecessary hospitalizations, inappropriate medical interventions, and poor overall coordination of care. This is true because chronic diseases are commonly treated but quite frequently not appropriately managed. The bulk of these expenses are spent on cardiovascular disease, cancer, diabetes, AIDS, orthopedic and spinal disease, arthritis, and the full range of neurological diseases. In countries with an aging population, the prevalence of chronic disease will increase dramatically, further accentuating the need for better chronic care.

Historically chronic disease has often been considered part of normal aging with little attention given to prevention, precise diagnosis and fully coordinated, long-term treatment. This view of chronic disease manifests itself with relatively late-stage treatments conducted as a series of acute interventions after a critical episode. Treatments after a critical episode are typically more invasive, expensive, and less effective at restoring an individual to a full health than treatments that could be given prior to episode if only the chronic disease risk or symptoms had been more accurately diagnosed. The medical profession's focus on late-stage treatment of chronic disease after a series of acute interventions has been influenced by the compartmentalization of medical specialties around acute diseases that often do not provide optimal treatment for chronic diseases. The medical profession's lack of attention to chronic disease has also been slow to change because of the largely passive role payers, employers, health care policy makers and patients have played in the past.

The medical profession's perspective on chronic disease is changing through increased knowledge and access to better data and more meaningful information that are changing historical views. Adding momentum to the medical profession's understanding of chronic disease is the empowerment of payers and patients. Payers are pressuring the medical profession to control the high cost of chronic disease treatment. Payers understand that chronic disease costs can often be substantially reduces through a better understanding of chronic disease risks, early and accurate diagnosis, appropriate intervention, and fully coordinated, long-term care. Patients are empowered with informational technologies to ask questions, understand disease risks and symptoms, understand alternatives including complimentary therapies, and seek treatments that improve both length and quality of life.

With the change in focus on chronic disease, there is recognition that the following chronic diseases that are not effectively managed: cancer, cardiovascular diseases, neurological diseases, musculo-skeletal diseases, diabetes, gastrointestinal diseases, and chronic pain. The chronic pain population is among the most difficult to identify, to accurately diagnose, and to manage. The result is that patients are commonly mismanaged, or managed in a non-uniform manner—resulting in signification health care treatment variability. Health care payers thus find it hard to predict health care utilization needs across a population base due to a poor understanding of the pain population and a lack of consistent care standards.

Previous efforts have also been particularly ineffective in accurately defining the care needs of a population and in personalizing care in a manner than provides effective treatment for a chronic pain patient that can be adjusted as a patient's health care condition or lifestyle changes.

For the foregoing reasons, there is a need for a chronic disease patient dynamic treatment plan system that permits personalized care planning over an extended period of treatment, making adjustments in the personal plan of care based upon changes in the patient's health care condition or overall lifestyle.

### SUMMARY OF THE INVENTION

The chronic pain patient can planning system can be a method or computer software product that creates a care plan for a chronic pain patient. Desired patient indicia including direct medical indicia, indirect medical indicia, and non-medical indicia are selected to serve as independent variables. At least one chronic pain indication is selected to serve as a dependent variable. A chronic pain care model is created using the patient indicia and the chronic pain indication. The chronic pain model is applied to a chronic pain patient to create a patient mathematical expression that represents a chronic pain patient care plan. Some embodiments can include establishing selection preferences that specify care plan characteristics desired to be selected by a stakeholder such as a patient, primary care physician, specialist physician, employer, or payer. The selection preferences are calculated with each potential chronic pain patient's mathematical expression to identify relationships between the selection preferences and each potential chronic pain patient's mathematical expression. Care plan characteristics are categorized based upon the relationships between the selection preferences and each potential chronic pain patient's mathematical expression. Some embodiments can include sensitivity analysis to improve accuracy of the chronic pain patient care plan. The sensitivity analysis includes comparing the chronic pain patient care plan with outside patient indicia to create a patient error list. An error assessment model is applied to the patient error list to identify the non-corresponding patient indicia that contributed to the errors. A sensitivity analysis model is applied to the non-corresponding to the non-corresponding patient indicia to identify potential patient indicia changes to reduce errors in creating a chronic pain patient care plan. At least one patient indicia change is selected from the potential patient indicia changes to apply to the patient indicia to modify the patient indicia. Many different embodiments of the chronic pain patient care plan system method and software product are possible.

### BRIEF DESCRIPTION OF THE DRAWINGS

FIG. 1 shows a block diagram of a chronic pain patient management system embodiment;

FIG. 2 shows a block diagram of a chronic pain patient care plan system embodiment;

FIG. 3 shows another block diagram of a chronic pain patient care plan system embodiment;

FIG. 4 shows a more detailed block diagram of a chronic pain patient care plan system embodiment;

FIGS. 5a-5b show a table of direct medical indicia prophetic example embodiment;

FIGS. 6a-6b show a table of direct medical indicia therapeutic agents prophetic example embodiment;

FIGS. 7a-7b show a table of indirect medical indicia prophetic example embodiment;

FIGS. 8a-8b show a table of non-medical indicia prophetic example embodiment;

FIG. 9 shows a block diagram of a chronic pain patient data preparation embodiment;

FIG. 10 shows a block diagram of a chronic pain care model development embodiment;

FIG. 11 shows a Chi-Square Automatic Interaction Detection (CHAID) analysis prophetic example embodiment;

FIG. 12 shows a logistics table prophetic example embodiment;

FIG. 13 shows a block diagram of applying preferences to a patient mathematical expression;

FIG. 14 shows a block diagram of a sensitivity analysis chronic pain patient care plan system embodiment;

FIG. 15 shows a more detailed block diagram of a sensitivity analysis chronic pain patient care plan system embodiment; and,

FIG. 16 shows a block diagram of a chronic pain patient care plan embodiment.

### DETAILED DESCRIPTION OF THE PREFERRED EMBODIMENTS

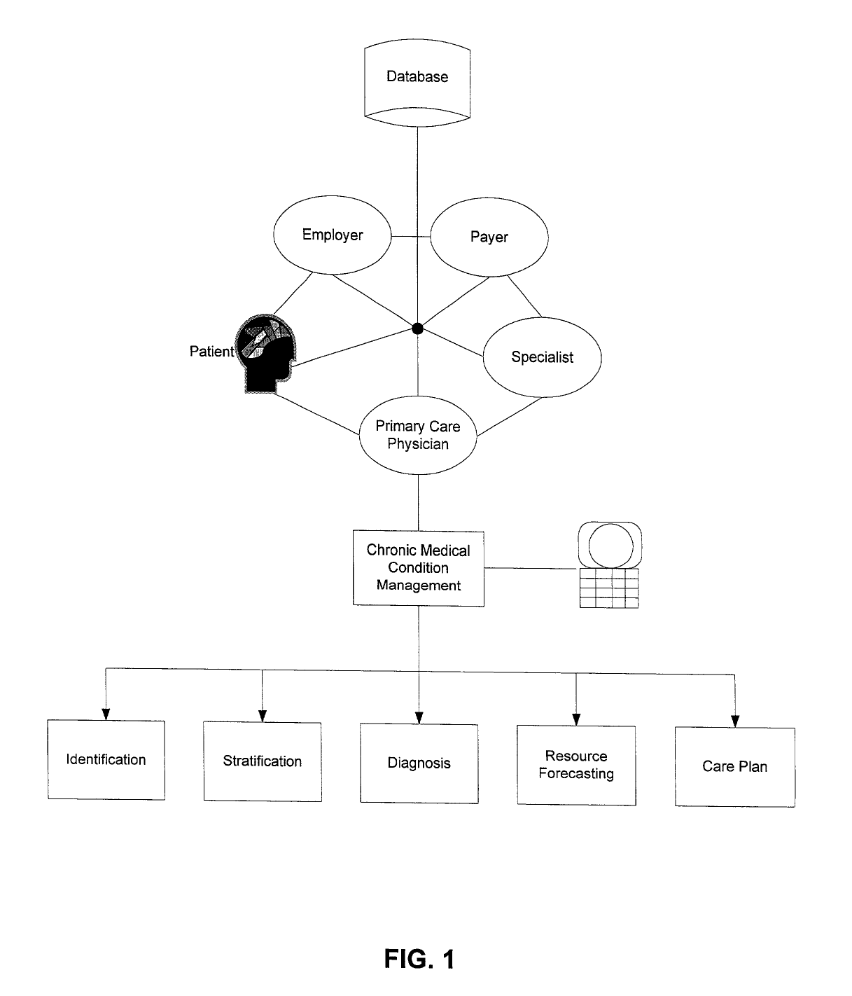

FIG. 1 shows a block diagram of a chronic medical condition management system embodiment and some elements of its operating environment. The chronic medical condition management system integrates the requirements and interests of at least five stakeholders include the patient, employer, payer, medical specialist, primary care physician, and the like. Other parties can also be added such as federal government, state government, allied health care professionals such as chiropractors, physical therapists, occupational therapists, and the like. The chronic medical condition management system can operate on data controlled by each stakeholder and on data contained in a common database. The management system can be operated on a variety of computer systems depending upon the complexity of the management system such as a personal computer, minicomputer, mainframe computer, super computer, and the like. The management system can contain one or more components such as a chronic pain patient identification system, chronic pain patient risk stratification system, chronic pain patient diagnosis system, chronic pain patient dynamic resource forecaster, and chronic pain patient dynamic care plan. All the stakeholders typically desire a health care delivery process that provides appropriate and efficacious care in a cost effective manner, but this desire takes on different meanings depending upon the perspective of the stakeholder. These perspectives are built into the software in the form of categorization preferences, which will later be taken into consideration when making software-driven choices. Since each stakeholder can use system-generated data for different purposes, each stakeholder can have a customized view and access to the data. The system also profiles these data needs as data preferences, and data is provided in accordance with customized data requirement profiles. Following is a brief discussion of each stakeholder's interest.

Employers are typically interested in resource stewardship, maintaining a safe work environment for their workers, enhancing work force productivity, and the like. From an employer's perspective, a safe, healthy, and happy work force translates into improved worker productivity. For this reason many employers strive to understand and meet the basic health care needs of their work force but seek to do so in a cost effective manner. Employers are more engaged than ever in designing benefit packages for their employees. They will typically endorse efficacious, lowest cost treatments and particularly those designed to promptly return an injured employee to work. To make such benefit decisions, employers need data. Information relating cost benefit analysis and similar data that will allow them to compare therapies based upon clinical effectiveness and cost is very useful. Return to work data is also of critical importance. There is a host of other data points that employers would find useful, but which is data that is not typically collected or well understood. For example, employers would find it helpful to better understand the cost of patient compliance vs. non-compliance with specific treatment options. Information that could profile an employee to predict patient compliance, could be crucial to the decision making process. Also, work environment data, such as knowing whether injury patterns can be identified among a work force, could allow employers to develop targeted strategies to reduce or eliminate work place injuries.

Payers are typically interested in ensuring that clinically effective care is provided to health care members in a cost effective manner that provides a high level of reported patient satisfaction. The role of the payer is evolving with time, and in the future, payers will become more involved in population management for specific disease states. For this reason, payers will require epidemiological data. Payers desire to be more involved in educating their members on specific disease states, personalizing responses to match the specific needs of their members. Additionally, payers require clinical and economic data in a format that business leaders are accustomed to using in the decision making process. In short, payers are evolving their data collection practices to become more practical partners with employers, as both parties strive to tailor benefits to meet the needs of a defined population of employees.

Specialist are typically interested in having patients referred that are appropriate for the specialist scope of practice. Health care payers increasingly demand more rigorous proof of therapy value. The evidence is requested in the form of clinical, quality of life and economic outcome studies, claims-based retrospective studies, or economic models. Physicians are becoming more involved in the data collection, interpretation and reporting process, and it is quite common for them to develop their own data bank of information on patient outcomes. In addition, the specialist is typically a part of a care team, and the primary care physician usually acts as the gatekeeper of care. Depending upon the primary care physician's approach toward care delivery, the care team is either loosely coordinated or more actively coordinated, or sometime not at all coordinated. However, care coordination is becoming more and more a valued process, as payers and providers are realizing that a seamless and more efficient care process has a direct impact on therapy outcome and cost. For this reason, it is important for the entire team to communicate with each other and to adopt uniform processes for care delivery and outcome reporting. As patients become more actively engaged in the care delivery process, the specialist is also striving to evolve the communication relationship with their patients. Patients are becoming informed consumers of health care services, and specialists are responding by creating new means of communicating with patients. For example, it is quite common for specialists to have their own patient-focused website.

Primary care physicians are typically interested in making a proper diagnosis of their patients and making a proper decision on when a patient should be referred to a specialist. The data and communication needs of the primary care physician are similar to those of a specialist. Additionally, the primary care physician is finding it of practical value to have disease specific information readily available across a broad array of topics. Patients are asking questions that are more detailed about their condition, and often approach physicians with information they pulled from the web relating to a potential therapy or new drug that might be of potential treatment benefit. Being a generalist by training, the primary care physician often finds it useful to easily access clinical summaries, suggested treatment standards or other similar information that helps them decide how to initiate the management of a condition.

Patients are typically interested in participating in their health care, proper diagnosis of their medical condition, and effective treatment of their medical condition. They are seeking to better understand their medical condition, and to become more actively informed in health care decision-making and more active participants in the treatment process. As more of the payment burden is shifted onto the patient, they also are becoming “care shoppers”, and therapy-specific economic data is more relevant to making an informed choice. Patients are also beginning to leverage web technology, using the web to get general disease information as well as to obtained more tailored information, programs or services that are personalized to their medical condition. The web is also being more frequently used as a means of communication between patients and their care providers, and is beginning to take the place of the telephone call and the physician office visit in the care delivery process. One component of the chronic pain patient management system is the chronic pain patient identification system.

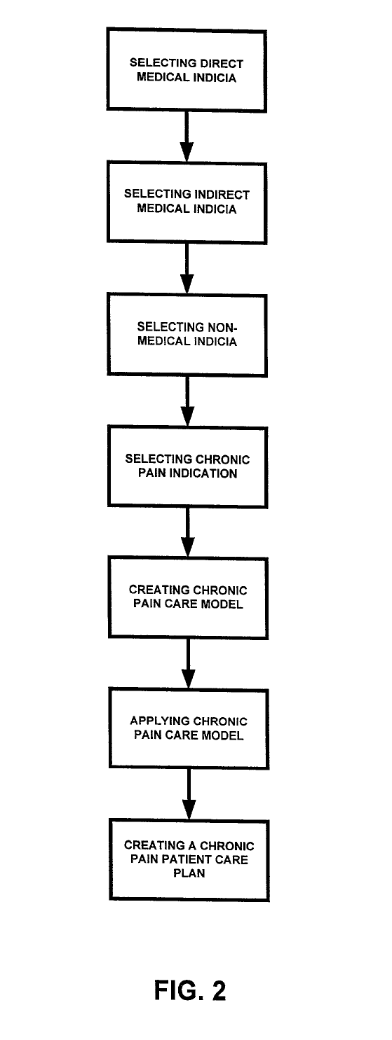

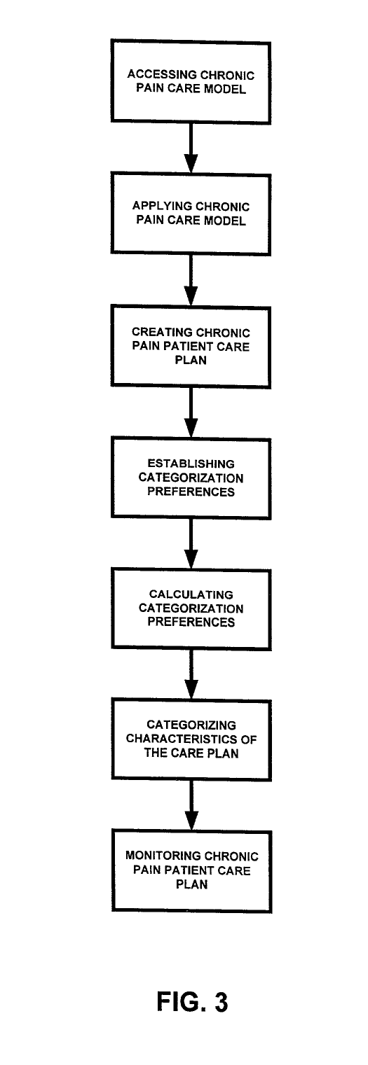

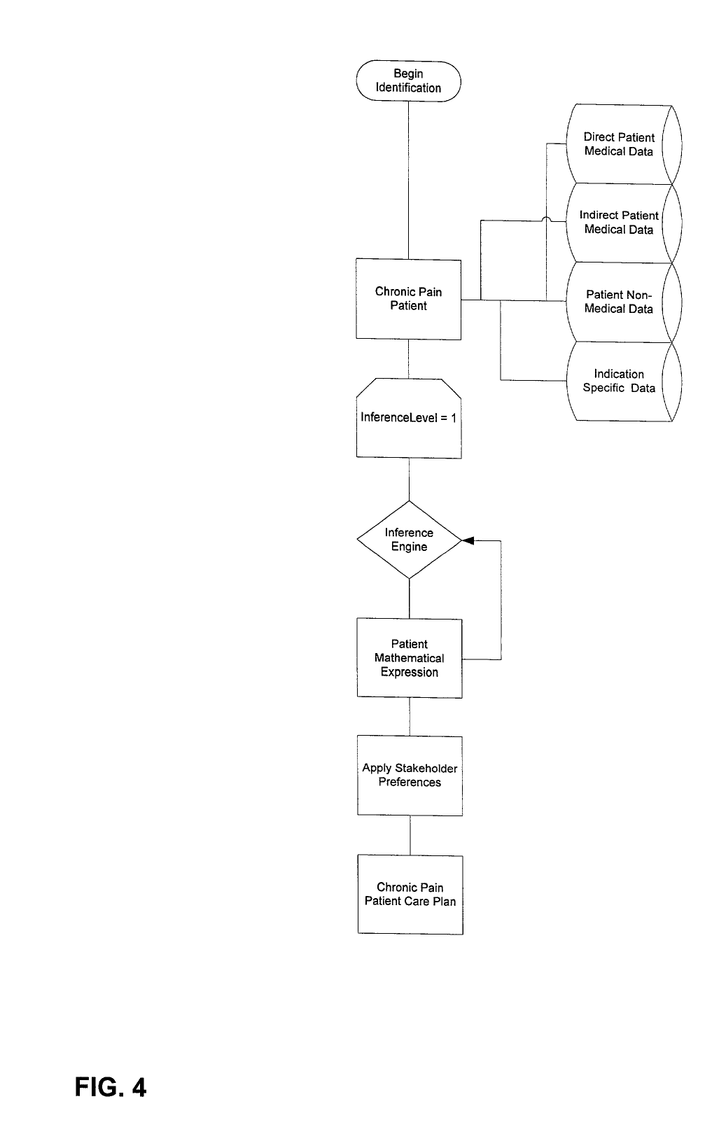

FIGS. 2 and 3 show block diagrams of chronic pain care plan system embodiments, and FIG. 4 shows more detailed block diagram of a chronic pain care plan system embodiment. The chronic pain patient identification system comprises the general elements of selecting patient indicia to evaluate, selecting a chronic pain indication, creating a chronic pain model using the patient indicia and the chronic pain indication, applying the chronic pain model to a chronic pain patient, and creating a chronic pain patient care plan. Additionally, some embodiments can include accessing the chronic pain care model, applying the chronic pain care model, establishing categorization preferences for desired categories chronic pain patient care plan characteristics, calculating the categorization preferences with each potential chronic pain patient's mathematical expression to establish relationships, categorizing the characteristics of the chronic pain patient care plan based upon these relationships, and monitoring the potential chronic pain patient. The patient indicia are selected from sources such as claims records, medical records, workers' compensation records, and employer records. The chronic pain model is applied to a population such as a payer database, employer database, primary care physician database, and the like.

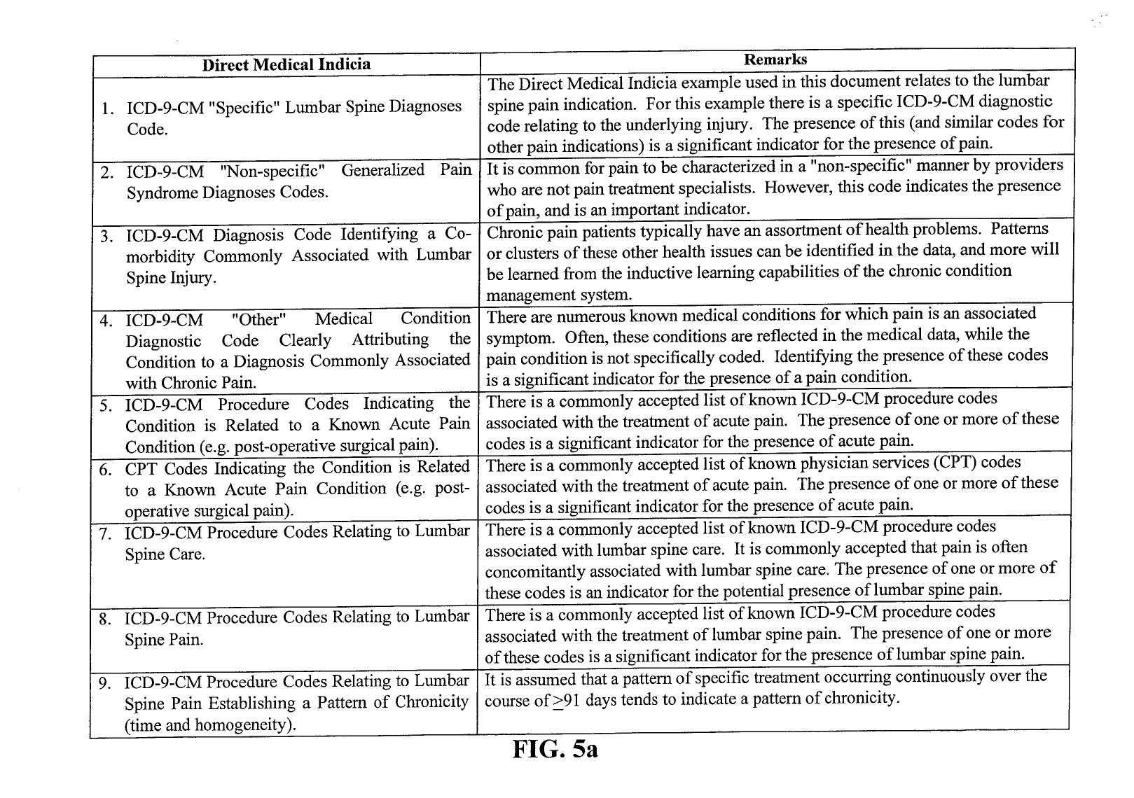

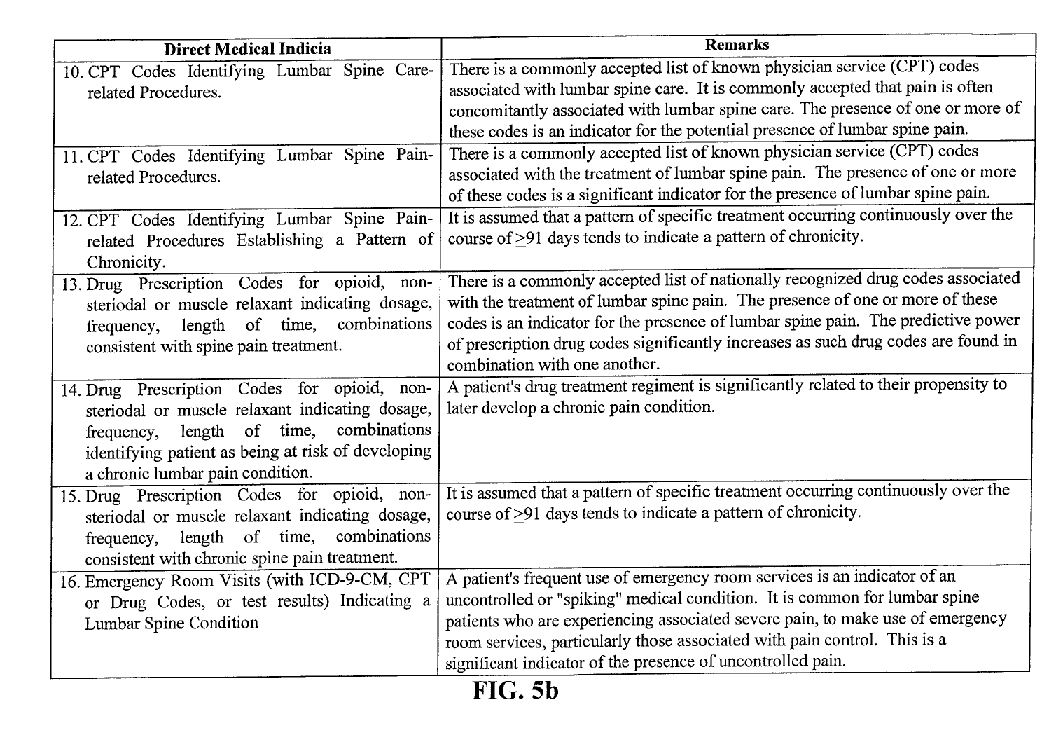

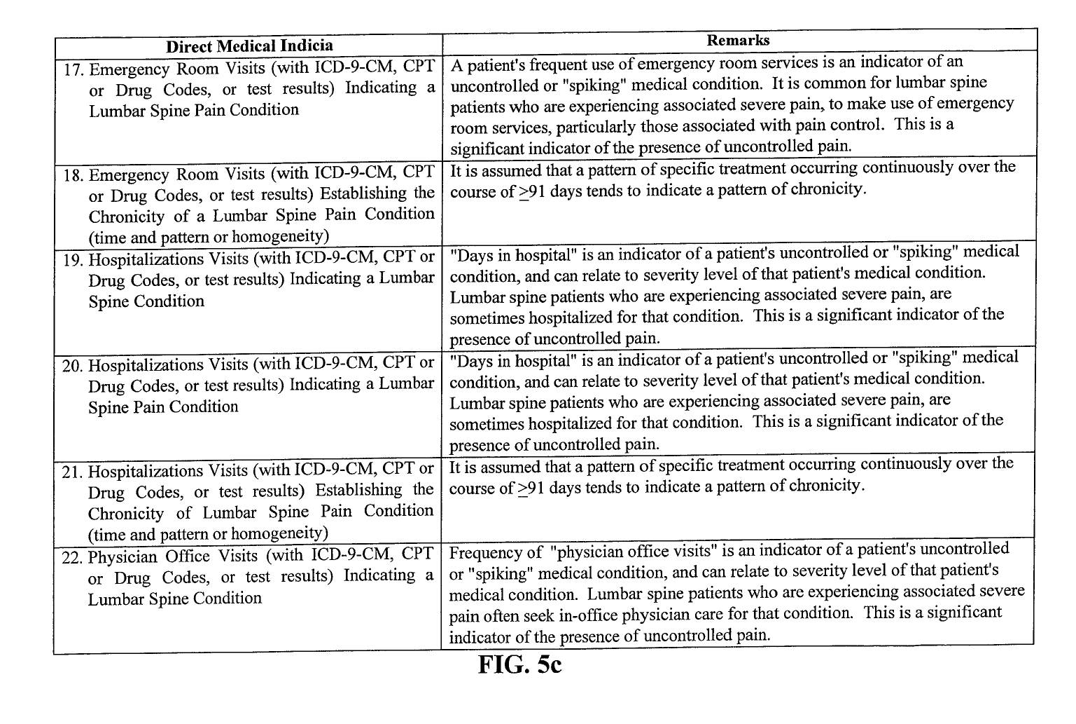

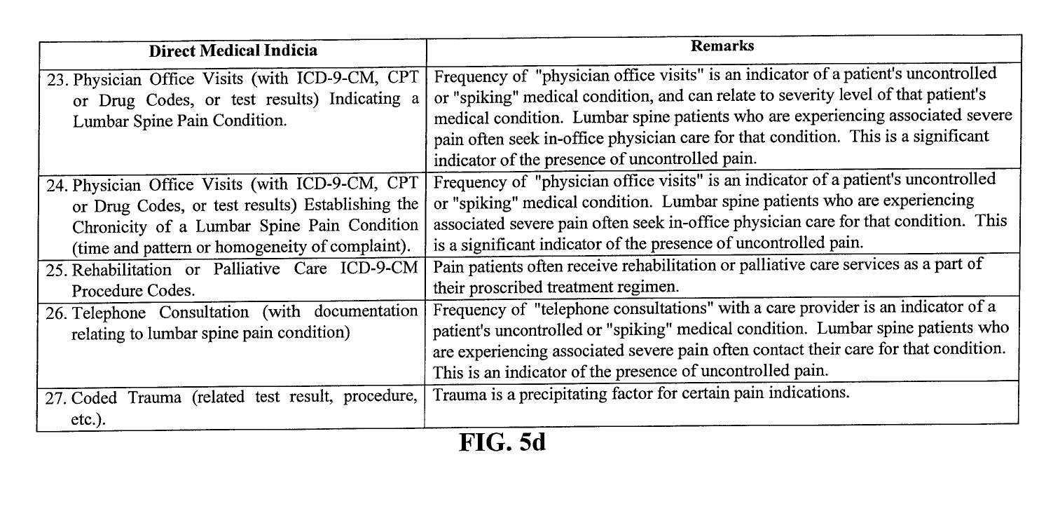

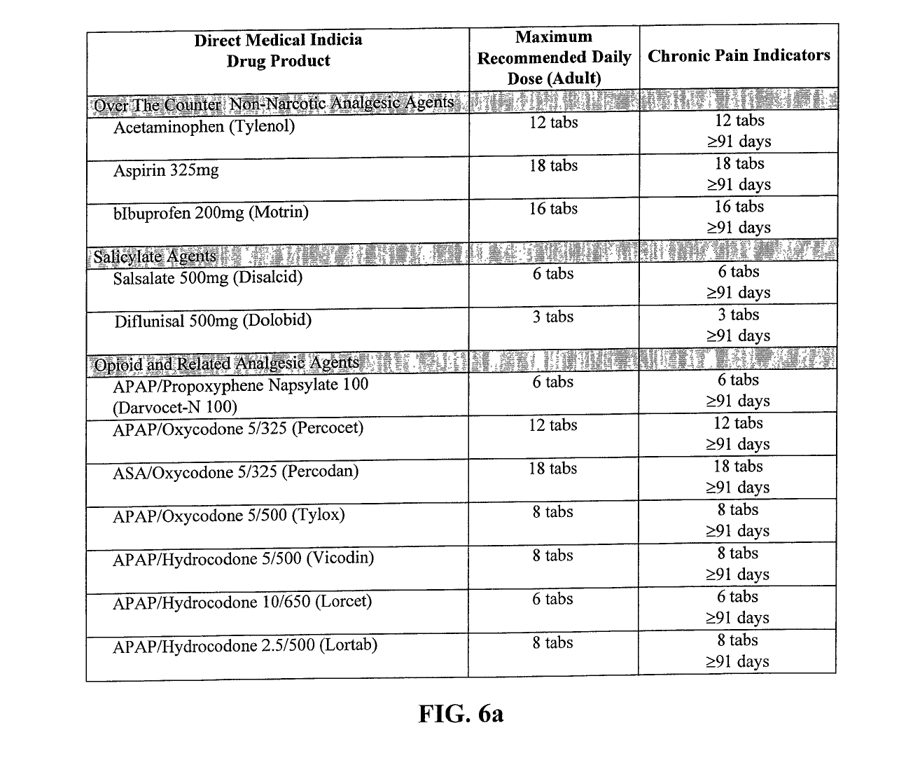

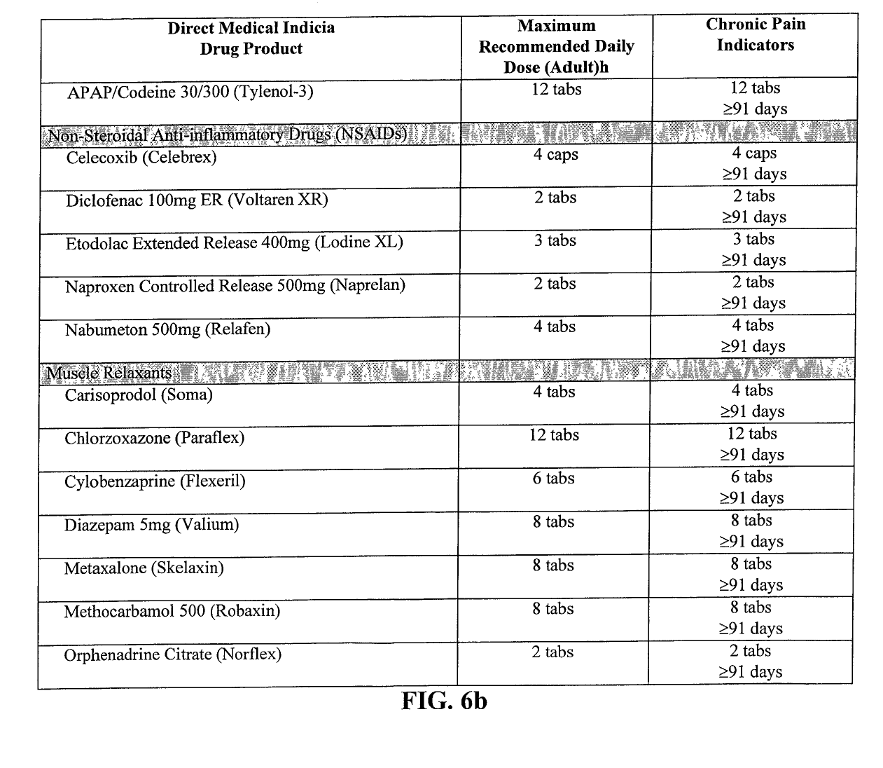

FIGS. 5a-5b show a prophetic table of some direct medical indicia related to chronic pain, and FIGS. 6a-6b show a prophetic table of some direct medical indicia in the form drug products. Although the indicia in FIGS. 5a-6b are labeled direct medical indicia, under some circumstance certain of these direct indicia could also be classified as indirect indicia. Patient indicia would actually be included in the chronic pain model and applied to a population.

Direct medical indicia associated with chronic pain are selected to serve as independent variables for the chronic pain model. Direct medical indicia include information, recorded by a clinician, relating to a chronic pain indication of a patient. In addition to the direct medical indicia shown in FIGS. 5a-6b, direct medical indicia can also include indicia such as primary diagnosis, associated secondary diagnosis, co-morbidities, drug treatment regimen, telephone consultations with a clinician, trauma episodes, palliative care, rehabilitative care, clinician office visits, emergency room visits, hospitalizations, and the like. Some direct medical indicia can be expressed as codes derived from nationally recognized coding systems such as International Classification of Diseases (ICD), American Medical Association Administrative Current Procedural Terminology (CPT); Healthcare Financing Medical Device Codes (HCPCS), and National Drug Codes (NDC) shown in FIGS. 5a-5b. Direct medical indicia are available from sources such as claims records, medical records, workers' compensation records, employer records, and the like. The importance of each of direct medical indicia is typically supported by the current body of chronic pain clinical literature, and can also be bolstered by expert medical opinion.

FIGS. 6a-6b show a prophetic table of some of the drug products that can be direct medical indicia. A patient's history of prescription and over the counter drug use can be a primary medical indicator of the existence of chronic pain, and in many cases provides adequate predictive evidence to cause a patient to receive a “positive in” classification. The type of drug, as well as the dosing level, and the length of time the patient has been using the drug, are all relevant characteristics in establishing a utilization pattern to support such a classification. Additionally, when certain drugs are used in combination with one another, the predictive power of the drug treatment regimen indicia becomes even more significant. For example, the medical literature indicates that muscle relaxants, anti-inflammatory drugs, anti-depressants, and opioid drugs are commonly prescribed to treat pain patients.

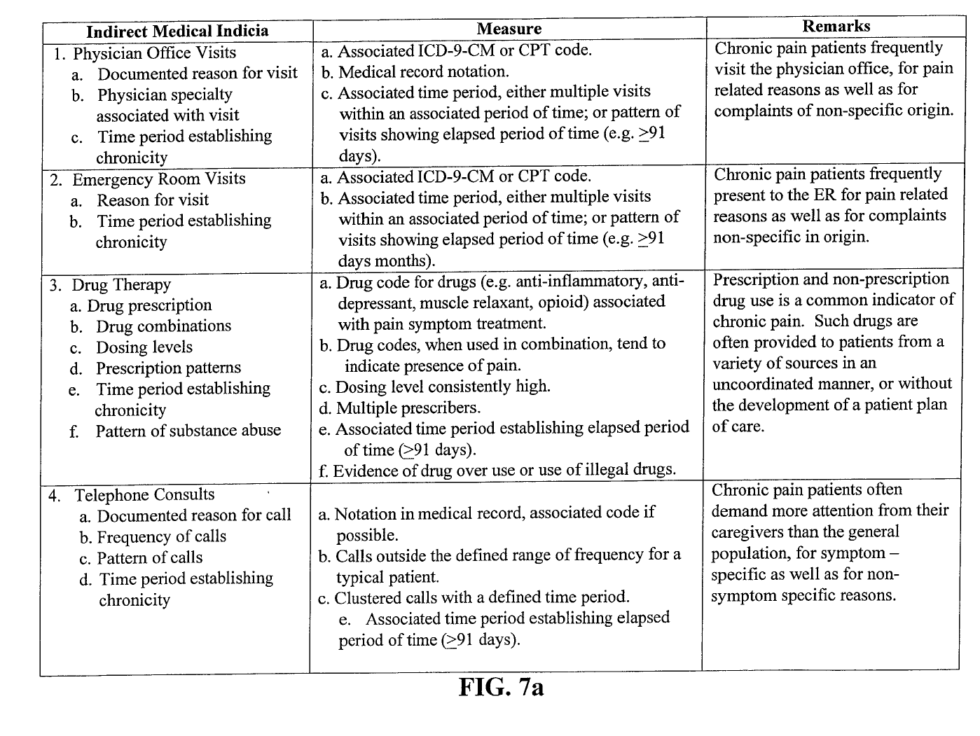

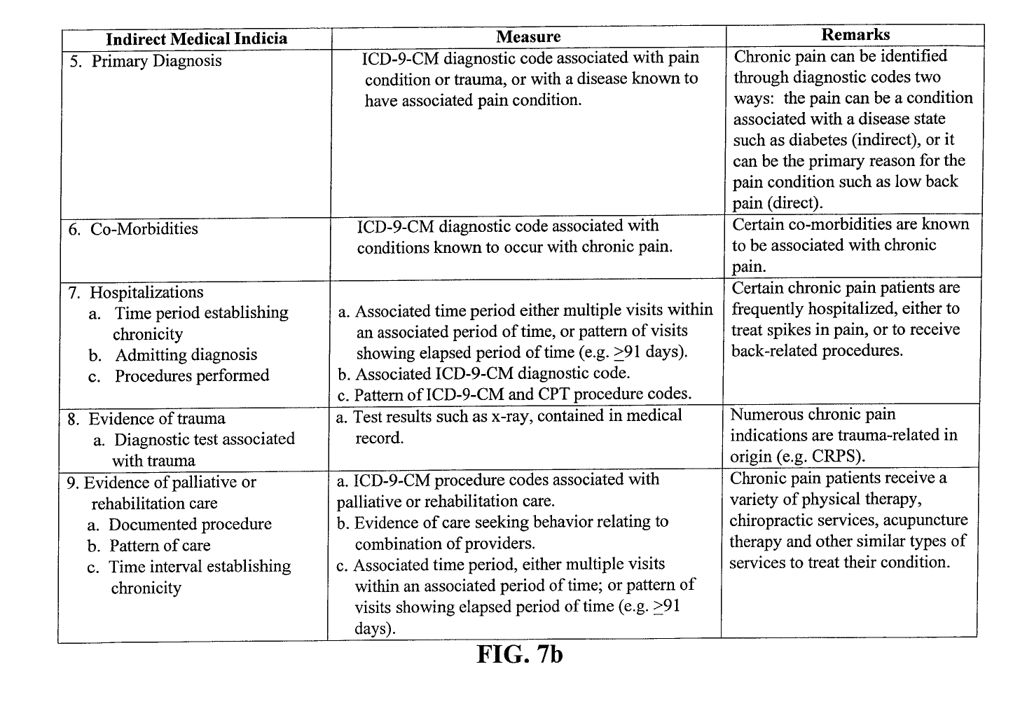

FIGS. 7a-7b show a prophetic table of some indirect medical indicia. Indirect medical indicia associated with chronic pain are selected to serve as independent variables for the chronic pain model. Under some circumstances, the indirect medical indicia could be considered direct medical indicia. Indirect medical indicia include information recorded by a clinician relating to a patient's health condition but non-specific to the disease of chronic pain. Studies support the link between direct and non-medical indicia in predicting the presence of chronic pain. Relevant indicia include such criteria as the patient's mental health status as indicated by a mental health ICD-9-CM diagnosis, as well patient's history of acute respiratory episodes requiring hospitalization or emergency room visits. It is believed that as much as 40% of a back pain patient's overall health care costs can be attributed to mental health treatment, and there is a link between smoking and all chronic disease.

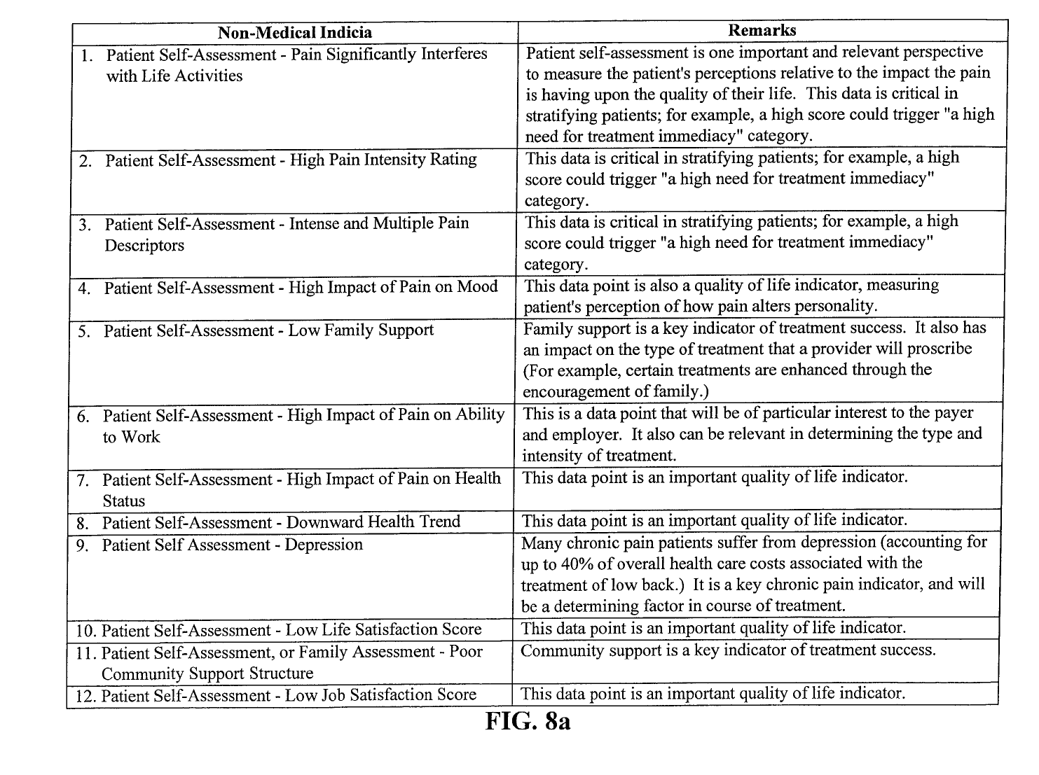

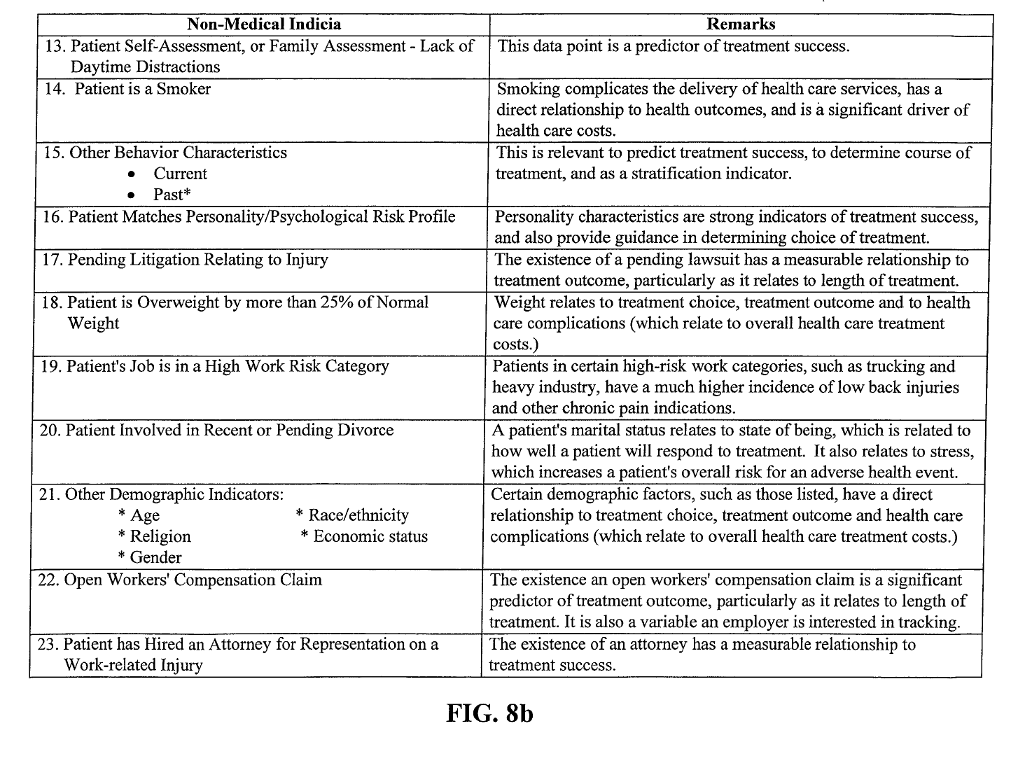

FIGS. 8a-8b show a prophetic table of some non-medical indicia. Non-medical indicia associated with chronic pain are selected to serve as independent variables for the chronic pain model. Non-medical indicia include all indicia related to determining or predicting a person's health care status that is not medical indicia. Less is known in the clinical literature about non-medical indicia as markers for the existence of chronic pain, than is known about medical indicia. Currently known non-medical indicia include socio-demographic factors such as: life style behaviors including alcohol consumption, smoking, weight gain, pain perception factors, life satisfaction measures, patient support structure from the family and the community at large, day time distractions, quality of their marital relationship, and personality and psychological profiles. Additional non-medical indicia include demographic factors such as age, gender, economic status, and race/ethnicity, the existence of an open workers' compensation claim, and the presence of an attorney hired by the patient to adjudicate a workers' compensation claim. Non-medical risk indicia are mined from such sources as medical records; patient self-report documents; patient self-assessment surveys; employer databases; workers' compensation records; medical chart reviews; telephone interviews with patients, treating clinicians, and family members.

Non-medical indicia are routinely used in U.S. state and federal courts by judges and members of a jury to assess whether a plaintive is suffering from a chronic condition such as chronic pain. Although indicia used by judges and juries may be based on personal experience and intuition, some of these non-medical indicia could be considered when preparing chronic pain model. Some non-medical indicia commonly used in a legal environment include courtroom demeanor, reputation for truth and veracity, demeanor of associates, and reputation of counsel.

A chronic pain indication, also known as a chronic pain condition, is selected to serves as a dependent variable for the chronic pain model. Chronic pain indications are published by professional organizations such as the International Association for the Study of Pain (IASP) and include the following indications Peripheral Neuropathy; Stump Pain; Phantom Pain; Complex Regional Pain Syndrome Type I (Reflex Sympathetic Dystrophy); Complex Regional Pain Syndrome Type II (Causalgia); Central Pain; Rheumatoid Arthritis; Osteoarthritis; Sickle Cell Arthropathy; Stiff Man Syndrome; Osteoporosis; Guillain-Barre Syndrome; Superior Pulmonary Sulcus Syndrome (Pancoast Tumor); Pain of Skeletal Metastatic Disease of the Neck, Arm, or Shoulder Girdle; Carcinoma of Thyroid; Post Herpetic Neuralgia; Syphilis (Tabes Dorsalis and Hypertrophic Pachymeningitis); Primary Tumor of a Vertebral Body; Radicular Pain Attributable to a Prolapsed Cervical Disk; Traumatic Avulsion of Nerve Roots; Primary Tumor of a Vertegral Body; Radicular Pain Attributable to a Thoracic Disk; Chemical Irritation of the Brachial Plexus; Traumatic Avulsion of the Brachial Plexus; Postradiation Pain of the Brachial Plexus; Painful Arms and Moving Fingers; Brachial Neuritis (Brachial Neuropathy, Neuralgic Amyotrophy, Parsonage-Turner Syndrome); Raynaud's Disease; Raynaud's Phenomenon; Frostbite and Cold Injury; Brythema Pernio (Chilblains); Acrocyanosis; Livedo Reticularis; Volkmann's Ischemic Contracture; Thromboangiitis; Intermittent Claudication; Rest Pain; Gangrene Due to Arterial Insufficiency; Other Postinfectious and Segmental Peripheral Neuralgia; Angina Pectoris; Postmastectomy Pain Syndrome (Chronic Nonmalignant); Late Postmastectomy Pain or Regional Carcinoma; Segmental or Intercostal Neuralgia; Chronic Pelvic Pain Without Obvious Pathology; Pain from Urinary Tract; Carcinoma of the Bladder; Lumbar Spinal or Radicular Pain after Failed Spinal Surgery; Spinal Stenosis (Cauda Equina Lesion); Pain referred from Abdominal or Pelvic Viscera or Vessels Perceived as Sacral Spinal Pain; Femoral Neuralgia; and, Sciatica Neuralgia. Although the chronic pain model typically considers only one chronic pain indication dependent variable at a time, there can be chronic pain model embodiments that would consider at least one and up to many chronic pain indication simultaneously.

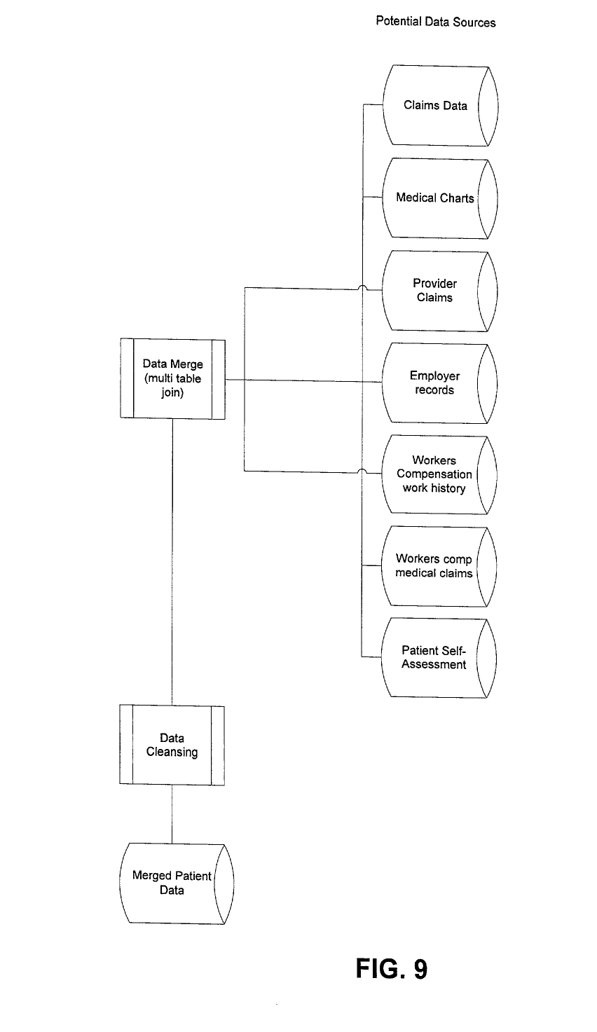

FIG. 9 shows a method for cleansing data such as patient indicia from potential data sources before the data is used in creating the chronic pain model. Often it is desirable to clean the data before the data is operated upon because data from various sources can have incompatible formats and data can contain errors. Data cleansing improves the reliability, accuracy and robustness of the chronic pain patient identification system.

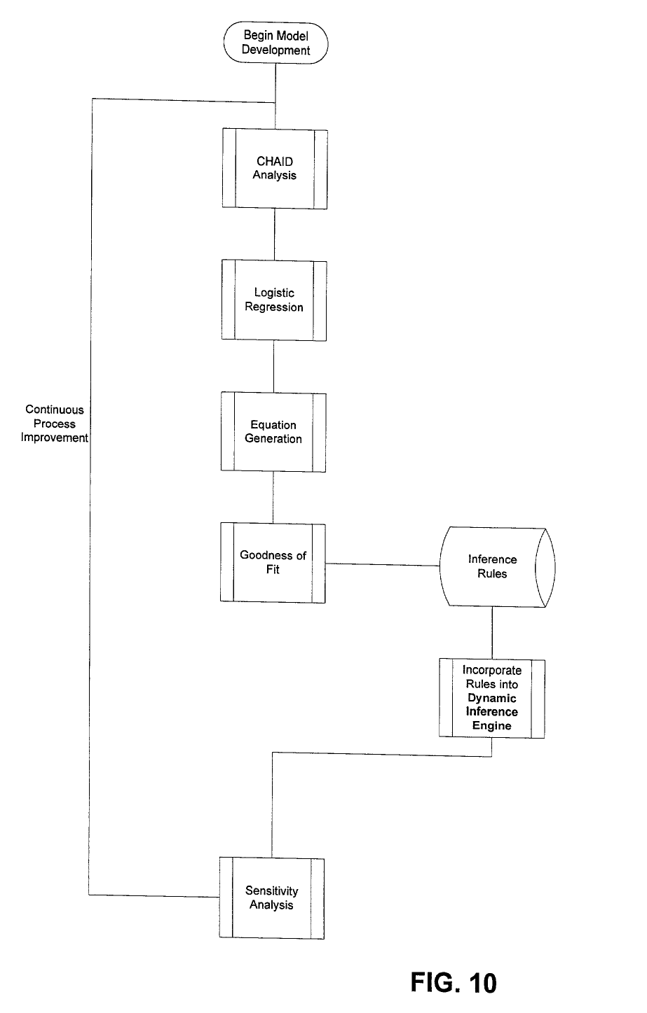

FIG. 10 shows a block diagram for creation of the chronic pain model in the form of a lochronic pain inference engine embodiment. The chronic pain model comprises a logic structure, weighted variables, and equations. Some embodiments of the chronic pain model can include B Hosmer-Lemeshow Goodness of Fit Analysis to evaluate the appropriateness of patient indicia, and monitoring patient indicia for changes that can be used to update the patient mathematical expression. The chronic pain inference engine can operate on at least fifty dependent variables, at least thirty independent variables, and at least fifty equations. The chronic pain model can be mathematically represented as follows: f(x)=b₀+b₁(X₁)+b₂(X₂)+b₃(X₃) . . . b₁(X₁) where b₀ is a beta weight constant; b₁−bᵢ are the beta weights for each corresponding variable; X₁−Xᵢ are the significant variables identified from the model; and f(x) is the resultant measure of the characteristic of interest, i.e., chronic pain score. This chronic pain model equation creates a line that represents the minimized average for the dataset that is the line of prediction for the dataset.

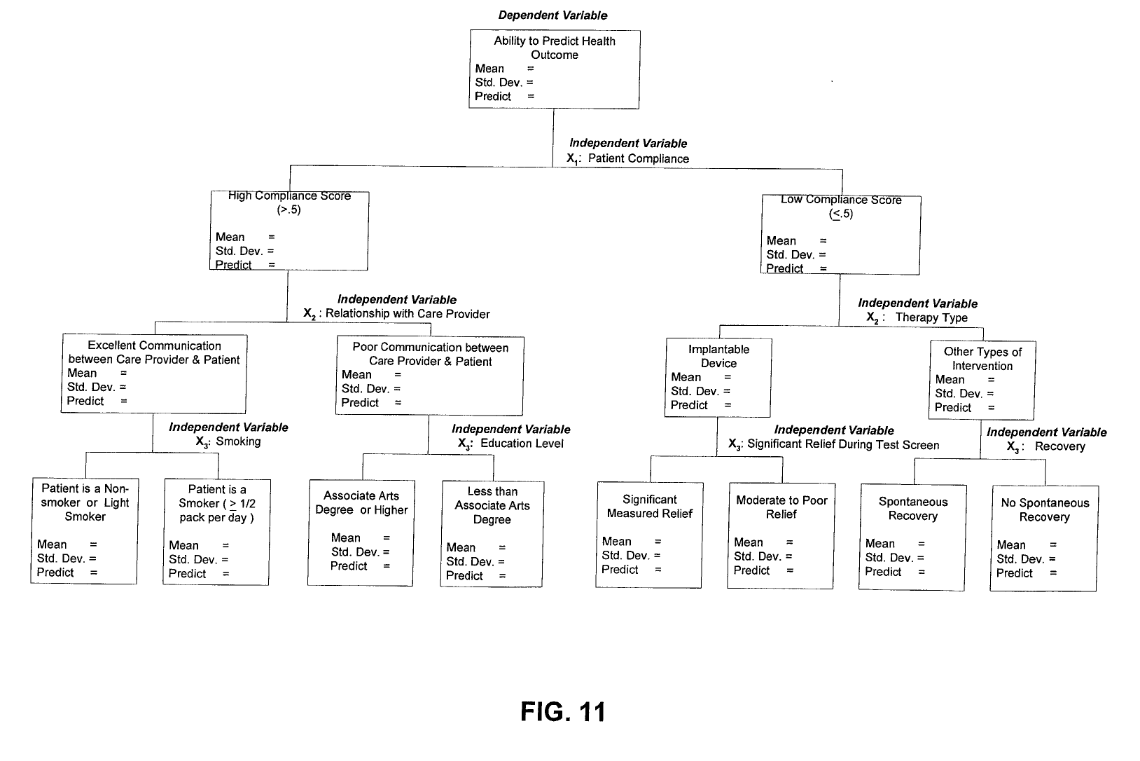

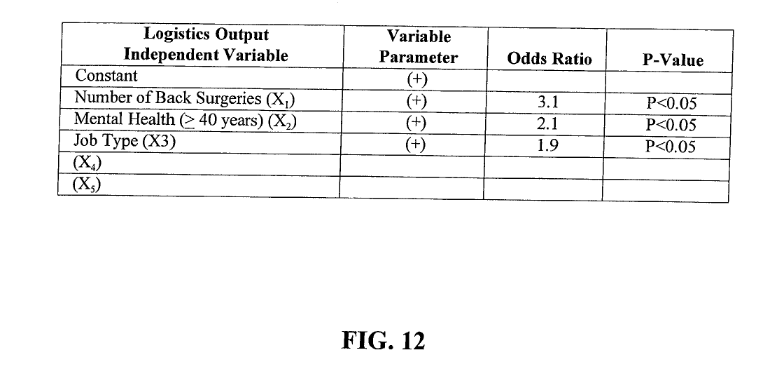

FIG. 11 shows a Chi-Square Automatic Interaction Detection (CHAID) analysis prophetic example embodiment, and FIG. 12 shows an analysis flow per indication prophetic example embodiment that was established by CHAID analysis. The logic structure used to establish relationships between a dependent variable and the independent variable can be developed using a statistical technique such as Chi-Square Automatic Interaction Detection (CHAID) analysis, CART analysis, and the like. The logic structure defines a logical decision process to progressively reach greater certainty about potential chronic pain patients. The logic structure can be evaluated using a statistical technique such as Hosmer-Lemeshow Goodness of Fit Analysis, and the like. CHAID is well known in the art, is an exploratory analysis executed to examine relationships that may exist between a dependent variable and multiple categorical variables that may interact with one another. It is predicated upon the supposition the necessary data is available, and that it is possible to distinguish, within a given data set, between two or more variables known to exist and known to be important.

CHAID is applied to the chronic pain construct in the following manner. Existing relevant information believed to be related to pain are culled from the clinical literature and bolstered by expert medical opinion, and a set of independent variables is identified based on current knowledge. As new clinical literature becomes available, the logic structure can be modified to include the new information. When the CHAID analysis is properly executed in a sequential fashion, the independent variables most clearly associated with the chronic pain measure will emerge.

The independent variables (predictors) are assessed to determine if splitting the sample based on these variables leads to statistically significant discrimination on the dependent measure. The most significant relationship defines the first split on the sample (called a branch or node). Then, for each group formed by the split, the remaining independent variables are assessed to determine which, if any, can further significantly discriminate on the subgroup. The end result (referred to as a terminal nodes) is a series of groups that are maximally different from one another on the dependent variable. At each step a statistical assessment is made to determine if a significant split into further subgroups can be made.

The length of the tree is the number of branches allowed to reach a terminal node. Tree length is set by the researcher and statistician based on decision rules. Based on the experience of the researcher, it has been determined that the model will continue branching until the variables found significant in differentiating the included population subsets establish nodes of N<15 individuals. This analysis will identify variables for inclusion only if they are determined to be significant at the p<0.05 level. It is assumed that incorporating several different sources of non-medical risk data (Patient Survey, Employer records, etc.) will provide the necessary precision. An alternative to CHAID is Classification Adjusted Regression Tree (CART) analysis. However, CART does not have the same efficiency in creating the buckets of patients.

The CHAID technique presents certain advantages for this analysis. It provides a means of detecting patterns in what is a complicated set of data. The maximum amount of data is used because missing values can be incorporated into the analysis. The analysis allows for a nominal level of measurement on the dependent variable and the independent variables. Finally, the resultant model will emphasize strong results without over-capitalizing on chance occurrences because the many variables are considered at once in a step-wise fashion. Thus, CHAID is extremely useful in detecting data trends. In addition, it will allow formation of meaningful interaction terms, which will inform the estimation of probability in subsequent logistic regression analyses.

FIG. 12 shows a table with a prophetic logistic regression example. The weighted variables reflect greater relevance of certain direct medical indicia, indirect medical indicia, and non-medical indicia to the chronic pain indication. The weighted variables can be developed using a statistical technique to establish relationships between the dependent variable and independent variables such as logistic regression, discriminant analysis, and the like. Logistic regression is a form of statistical modeling appropriate for categorical outcome variables. The method examines the relationship between a categorical response, or dependent variable, and a set of explanatory, or independent variables. The results of logistic regression provide regression coefficients. The coefficients can be as simple as a single numerical value or as complex as an equation including known independent variables. After transformation, the regression coefficients can be interpreted as odds ratios describing the influence of various factors and the dependent variables. The logistic regression procedure provides odds ratios for independent variables as well as the significance level for each odds ratio. For example, the process could provide that employees with job types where heavy lifting is characterized as a major function of the job, are three times more likely to be chronic low back pain sufferers than employees with other job types. As with CHAID analysis, the many independent variables will be considered in a stepwise fashion, which allows for detection of the most explanatory of the variables. To be included in the logistic model variables must achieve a significance level of p<0.05.

Because the dependent variable has only two possible values (either chronic pain is present or it is not), it is not correct to assume that the variable would be normally distributed in a sample of individuals. By transforming the variable using a logistic function, the variable is made to appear closer to a normal distribution than would otherwise be the case (the assumption of a normal distribution being essential to the use of a linear statistical procedure). Taking into account the logistic transformation, the mathematical equation (or logistic function) that results from analysis takes the form:

$$Log \frac{}{1 - p} = {b}_{0} + {b}_{1} ( {X}_{1} ) + {b}_{2} ( {X}_{2} ) + {b}_{3} ( {X}_{3} ) + {b}_{4} ( {X}_{4} ) ⃛ {b}_{i} ( {X}_{i} )$$

where p is probability; b₀ is a beta weight constant; b₁−bᵢ is the beta weight for each corresponding variable; and X₁−X₁are the significant variables identified from the model, e.g., X₁ can be job type, X₂ can be gender and job satisfaction, and X₃ can be Drug Therapy, Number of Children and Gender. This logistic regression equation is further complicated by the potential interactions, described mathematically as follows: b(X₁·X₂). An alternative to Logistic Regression is Discriminant Analysis. Discriminant Analysis requires looking at extreme groups of patients. In order to find the most efficient group, the process requires a mix of extremes. Once logistic regression has been complete, equations can be generated.

Equations are generated to represent relationships between or among weighted variables to build a chronic pain inference engine. The chronic pain inference engine can operates on at east fifty dependent variables; at least thirty independent variables; and, at least fifty equations. The potential chronic pain patients are identified with a patient mathematical expression generated by the chronic pain inference engine operating on the patient indicia and the chronic pain indication. The patient mathematical expression can be used to administratively categorize the potential chronic pain patient into a category such as Positively-In, Positively-Out, Probably-In, Probably-Out, and the like. After a potential chronic pain patient is identified with a mathematical expression, that potential chronic pain patient's patient indicia can be monitored for relevant changes and the potential chronic pain patient's mathematical expression can be updated to reflect those changes. The computer will generate odds ratios and related significance levels as an output. Interpretation of results is a simple exercise of examining the sign (the direction of the parameter estimate), the value of the odds ratio, and it's significance level.

The number of equations generated can become quite large such as thousand and millions or equations associated with each chronic pain indication dependent variable, and currently there are 456 seperate cronic pain indications. Due to the complexity and large number of equations, a computer is typically required to calculate the equations to produce a patient mathematical expression. A prophetic example of the number and complexity of equation generation follows. It is known that there are at least 456 different indications for chronic pain. Assume a predictive model that accounts for each of these 456 dependent variables. Further assume that there are currently a total of 32 identified indicia for chronic pain, adding the medical and non-medical indicia together (this number will grow as more is learned about chronic pain). If the model is developed out to the fourth level of independent variable (X₄) the calculation is as follows:

| Step | Equation Possibilities |
|---|---|
| 1 | Each indicia is considered individually: 32 total |
| | possibilities. |
| 2 | Each indicia is crossed with every other indicia for a |
| | two-way interaction calculation: 32 × 31 = 992 total |
| | possibilities. |
| 3 | Each indicia is combined in a three-way interaction |
| | calculation: 32 × 31 × 30 = 29,763 total possibilities. |
| 4 | Each indicia is combined in a four-way interaction |
| | calculation: 32 × 31 × 30 × 29 = 863,040 total |
| | possibilities. |
| 5 | Total possibilities are added together: 893,827 total |
| | possibilities. |
| 6 | The model is run 456 different times with 893,827 |
| | possibilities for each of these 456 indications. |

* If a fifth independent variable is presented, the possibilities increase to: 25,058,947 total possibilities.

In the addition to the complexity introduced by interaction terms, each time a new variable is identified and introduced into a model the logistic function must be regenerated. Any newly identified variable can dramatically affect the resultant model (the number of variables found to be significant, the value of the odds ratios found, and the directional relationship of the variables). New variables can be found to have significance when compared with previously tested variables and new variables can change the significance level of previously significant and non-significant variables or can change the way previous variables interact with either the new variable or previously identified variables. Thus as our knowledge of chronic pain expands, model generation must be revised, creating a dynamic knowledge opportunity limited only by our ability to identify and appropriately measure (both validly and reliably) additional variables and our ability to refine measurement of previously identified variables.

The potential complexity of chronic pain model can be seen from the following prophetic example. In the applied CHAID example, X₁ is “Job Type”. If it is discovered that X₁ is “Injured Employee Retains an Attorney”, every other independent variable is potentially altered. This alteration includes order of importance, clusters of importance, and even relevance in terms of predictability. If X₁ becomes “Injured Employee Retains an Attorney”, X₂ could likely become “Unresolved Workers Compensation Claim”. The weighted value of the cluster of these 2 indicia could be significantly higher than the cluster of the previous 2 indicia of “Job Type” and “Gender or Job Satisfaction”. The potential patient indicia, their importance and weight, alone and in combination with others can be immense.

The Hosmer-Lemeshow Goodness of Fit tests the models and determines whether the variables chosen for the model were the best possible. Once the logistic model is determined, the Hosmer-Lemenshow Chi-Square statistic is calculated to assess the goodness of fit of the model. A non-significant value indicates an adequate goodness of fit. If the Hosmer-Lemeshow analysis indicates that there is not a good fit, then the conclusion drawn is that there are variables other than those identified for model inclusion that might better explain the concept being investigated. This is an indication that further identification of variables and data sources for those variables must be determined.

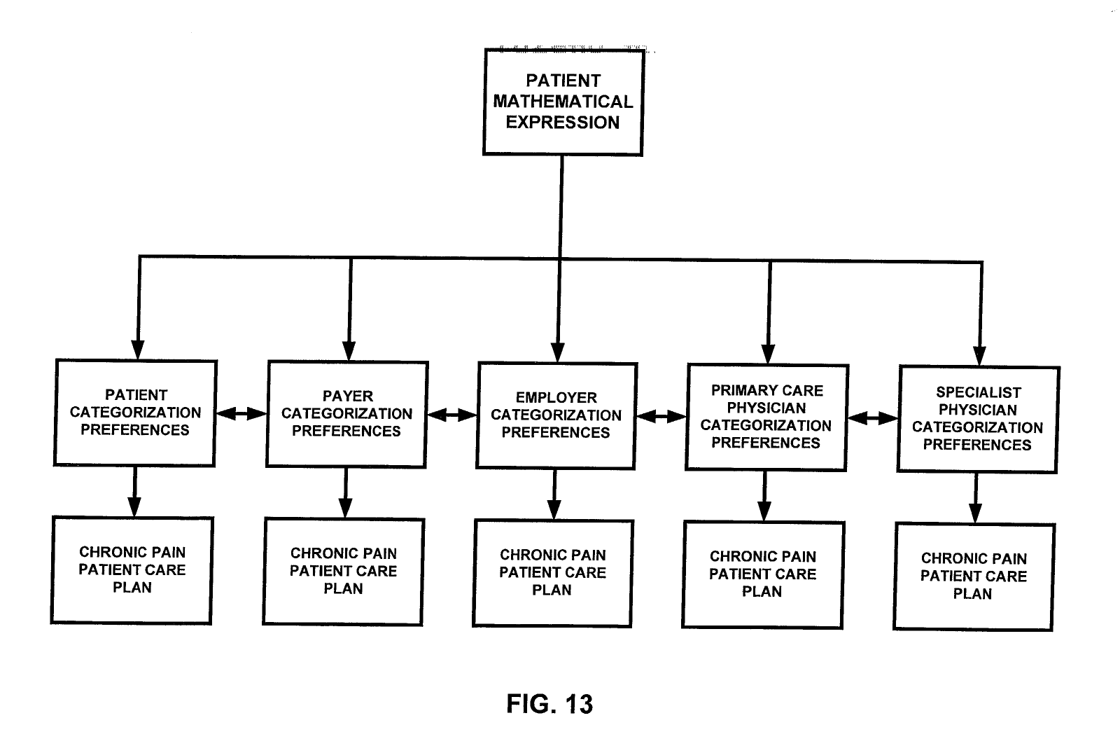

FIG. 13 shows a block diagram of applying categorization preferences to a patient mathematical expression embodiment. Potential chronic pain patient's can be categorized by first establishing categorization preferences that specify characteristics of patients desired to be categorized. The categorization preferences include patient categorization preferences, payer categorization preferences, employer categorization preferences, primary care physician categorization preferences, and specialist physician categorization preferences. The different stakeholder categorization preferences can be interrelated. For example, a payer categorization preference can include a potential chronic patient preference that might indicate whether the potential chronic pain patient would be compliance with a physical therapy regimen. Some examples of categorization preferences for a patient can include a desire to be notified of being a potential chronic pain patient even though the other stakeholders categorization preferences do not identify the patient as a potential chronic pain patient, a desire to not be notified of being a unless the other stakeholders would support treatment, a desire to not be notified under any circumstance of being a potential chronic pain patient. Some examples of categorization preferences for a payer include a desire to know if potential chronic pain patient reimbursement criteria are met and a desire to know whether the potential chronic pain patient special care program criteria are met. Some examples of categorization preferences for an employer can include a desire to know potential chronic pain patients who's job performance may be affected and potential chronic pain patients that can be efficiently treated. Some examples of categorization preferences for a primary care physician can include potential chronic pain patients that are suitable for treatment by the primary care physician and potential chronic pain patients that should be considered for referral to a specialist. Some examples of categorization preferences for a specialist physician can include potential chronic pain patients that are suitable for treatment by the specialist physician and potential chronic pain patients that should be considered for referral to a primary care physician.

The categorization preferences are calculated against each potential chronic pain patient's mathematical expression to identify relationships between the categorization preferences and each potential chronic pain patient's mathematical expression. Calculation of categorization preference can range from simple search and find algorithms to complex statistical models such a modified chronic pain model.

The software assigns an alphanumeric score for each patient identified under the rules of the inference engine. The number score, based upon a 0-100% rating, relates to the level of predictive confidence that an appropriate candidate has been identified. Patients with a confidence rating of ≧85% will be considered as potential chronic pain patients, and their names will be passed along to a primary care physician for an initial determination of program inclusion or exclusion. Patients with a lower than 35% rating will be excluded from further consideration. Patients with a score in the range of 35%-85% will be held in the system for up to one year, and the receipt of new information could alter their score upward or downward—triggering program inclusion or exclusion.

Letter designations represent pain type, site, or etiology, as coded or described in the data, as well as any other rules-based, identifying characteristics or profiles of pain. For this reason, patients can receive more than one letter designation. For example, a patient suffering from chronic peripheral neuropathy would receive an “E” designation. (See Figure). If the patient were also diabetic, he or she would also be designated as a “V”. It should be noted that a patient's letter designation is subject to change, based upon the receipt of additional relevant data. If no such feature can be identified from the data query, the letter Z is assigned.

The following table lists the letter designations and explains the meaning of each designation. As system knowledge increases, this list will change through addition, deletion or modification.

Patient Rating System Table

| Designation | Definition |
|---|---|
| A | Cardiac (Anginal Pain) |
| B | Low Back |
| C | Cancer |
| D | Failed Back Surgery Syndrome |
| E | Peripheral Neuropathy |
| F | Head, Face or Mouth |
| G | Repetitive Motion Injury |
| H | Urinary Tract |
| I | Stump Pain |
| J | Central Pain |
| K | Complex Regional Pain Syndrome |
| L | Causalgia |
| M | Chronic Pelvic Pain |
| N | Arthritis |
| O | Post Herpetic Neurology |
| P | Osteoporis |
| Q | Spinal Cord Injury |
| R | Sickle Cell Arthropathy |
| S | Heavy Smoker |
| T | Trauma |
| U | Heart Failure |
| V | Diabetic |
| W | Work-related Injury |
| X | Psychological Profile |
| Y | Addications |
| Z | No Identified Characteristics |

Once potential chronic pain patients are selected, the potential chronic pain patient's patient indicia can be monitored to detect changes that can affect whether the potential chronic pain patients remain potential chronic pain patients or are no longer potential chronic pain patients. The selected potential chronic pain patient's direct medical indicia, indirect medical indicia, and non-medical indicia are monitored for changes and the patient's mathematical expression is updated based upon changes to the potential chronic pain patient's direct medical indicia, indirect medical indicia, and non-medical indicia.

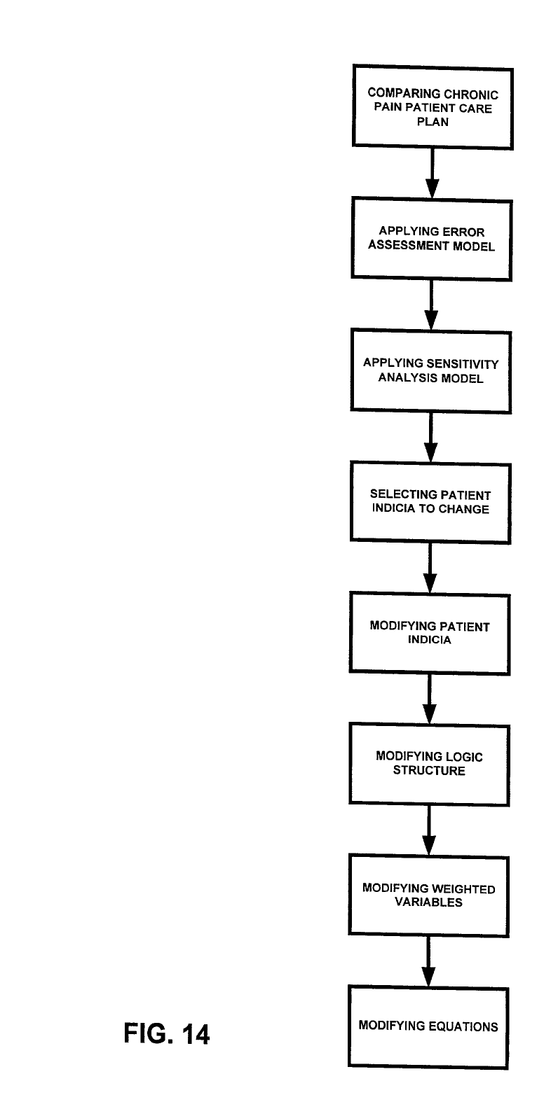

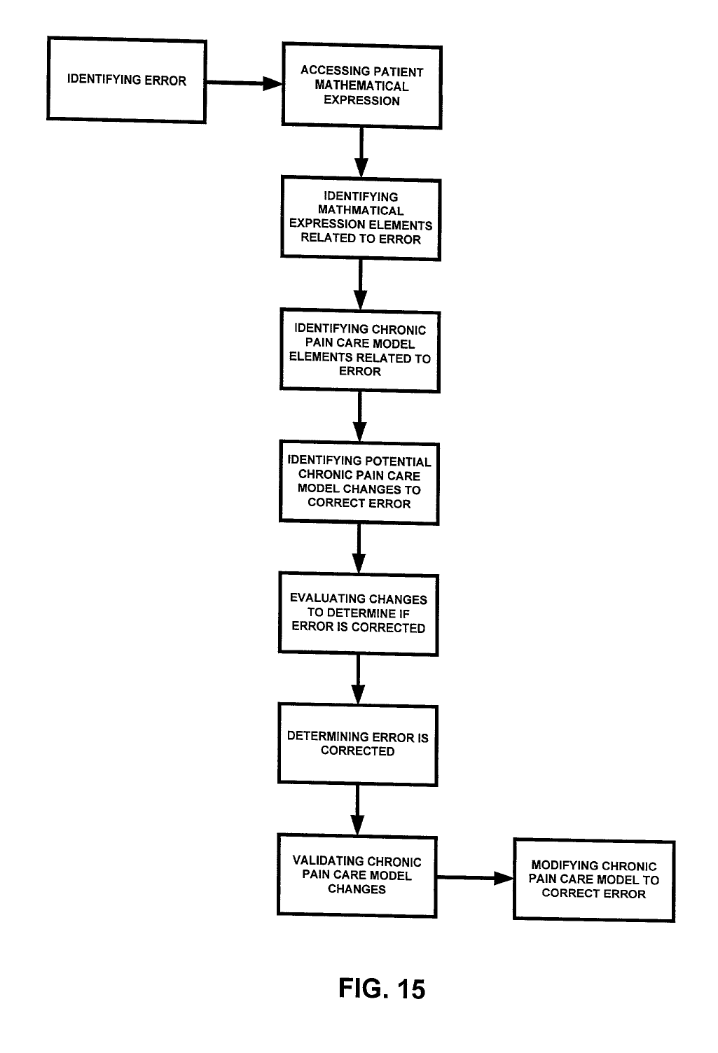

FIG. 14 shows a block diagram of a method of sensitivity analysis of a chronic pain model embodiment, and FIG. 15 shows a block diagram of applying a sensitivity analysis model. The method can begin by comparing the identified potential chronic pain patients with outside diagnosed chronic pain patient data to create a patient error list. The outside diagnosed chronic pain patient data would typically include diagnosis information such as laboratory test results, patient survey data, physiologic measures, the specific chronic pain indication, and the like. Sources for outside diagnosed chronic pain patient data include medical claim data, medical charts, employer records, worker compensation records, and the like. The patient error list has an error assessment model applied to the patient error list to identify non-corresponding patient indicia that contributed to the errors. The non-corresponding patient indicia are typically the absence of one or more patient indicia or the inclusion of one or more extraneous patient indicia. The non-corresponding patient indicia has a sensitivity analysis model applied to the non-corresponding patient indicia to identify potential patient indicia changes to reduce errors in identifying chronic pain patients. Examples of potential patient indicia changes include the addition of one or more relevant indicia or the exclusion of one or more extraneous patient indicia. At least one patient indicia change is selected from the potential patient indicia changes for changing. Finally, the patient indicia are modified with at least one selected patient indicia change. The modified patient indicia typically improve accuracy of the method for new patients entered into the system because new patient indicia may be required. The modified patient can improve the accuracy of the method for patients currently entered into the system particularly if patient indicia are excluded.

The chronic pain model weighted variables can also be modified in a manner similar to the patient indicia. The sensitivity analysis model is applied to the weighted variables to identify potential weighted variable changes to reduce errors in identifying chronic pain patients. At least one weighted variable change is selected from the potential weighted variable changes to apply to the weighted variables. The weighed variables are modified to reflect greater or lesser relevance of patient indicia to reduce errors in identifying chronic pain patients.

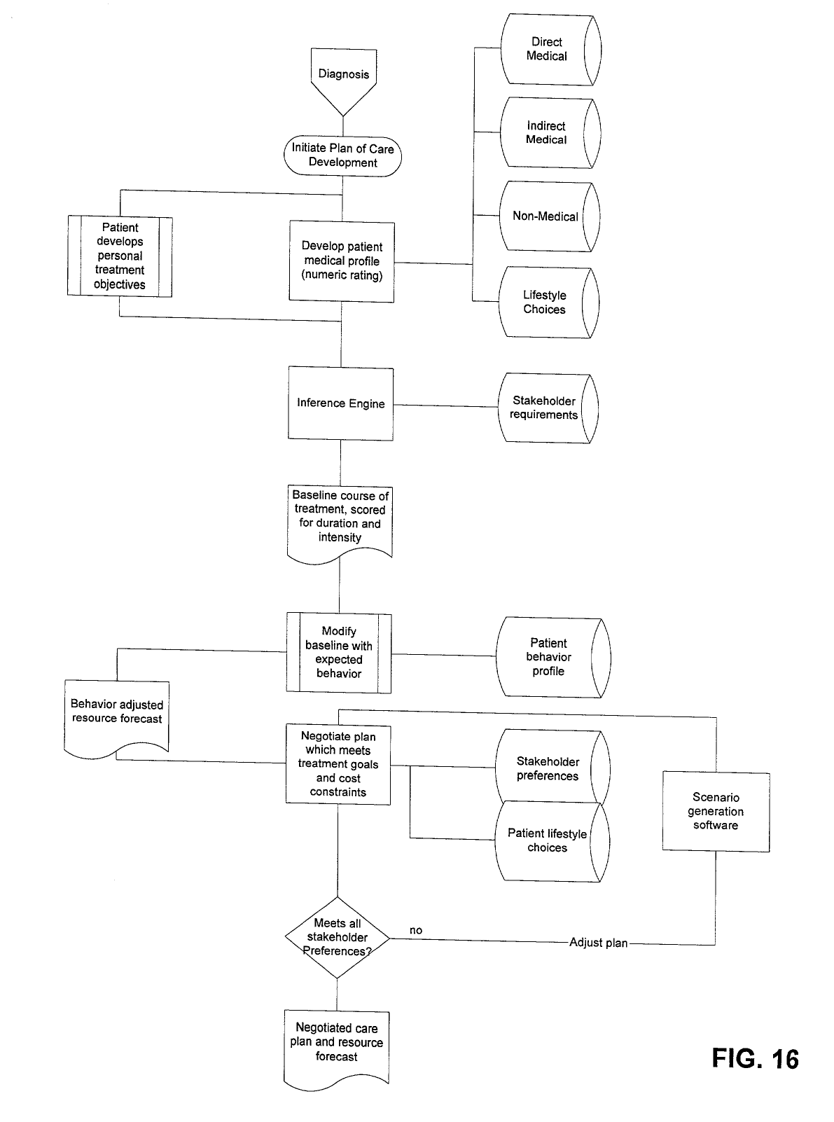

FIG. 16

### Prophetic Example

The Care Plan applies a dual process of health care treatment modeling and care plan negotiation among the interested stakeholders, to the development of a personalized, dynamic plan of care. To facilitate this process, a variety of “profiles” and “preferences” are developed and applied to the model. These “profiles” and “preferences” are briefly described as follows.

Four patient-specific profiles are developed and incorporated into the modeling and care negotiation process: Patient Treatment Goals Profile; Medical (direct and indirect medical indicia) Profile; Behavior Profile; and Lifestyle Choices Profile. Additionally, the care plan development process incorporates payer-specific payment preferences, described in the form of patient-specific covered services and benefits. Finally, the process incorporates stakeholder-specific preferences, which are used in the negotiation process leading to a final personalized plan of care, and the initiating of treatment. The plan of care development process is described below.

The patient completes a questionnaire to establish patient-specific treatment goals. Next, a patient-specific Medical Profile is developed, from the medical (direct and indirect) indicia found in claims data, medical records and patient self-report documentation. The patient's Medical Profile, along with identified treatment goals, is later used to determine a baseline course of treatment appropriate to the patient' s diagnosis, past medical history, present medical condition and articulated care goals.

The Medical Profile is expressed as a line item specific mathematic score, and a composite score, also written in the form of a mathematic expression. The mathematic expression will later translate into a prioritized plan of care, with intensity level and treatment duration also suggested by the model. The categorization preference items are information items relevant to a stakeholder such as primary diagnosis, secondary diagnosis, depression diagnosis, pattern of mental health services consumption, trauma, pattern of chronic drug use, pattern of emergency room visits, pattern of hospitalizations, and pattern of chiropractic intervention.

To generate a baseline course of treatment, the logic of the Inference Engine suggests the key medical indicia to consider, defines relationships among the medical indicia, and creates the weighted value describing the importance of each medical indicium. The Inference Engine, with these pre-defined relationships established among the key medical indicium, produces an output, with consideration given to patient's treatment goals, suggesting a stepwise treatment baseline in the form of mathematic expressions for each treatment step. (The treatment baseline plan suggested by the model, including the suggested intensity level and duration of treatment is determined from the medical literature as well as from medical and pharmaceutical claims data. These protocols will be continuously updated, in a closed-loop fashion, from data collected and added to the Inference Engine logic.) The treatment baseline includes, at a minimum: each prioritized treatment step, along with suggested treatment intensity level and time duration. The mathematic expressions relating to the treatment steps are then aggregated, and a total score is developed for each patient. This score will be used in the plan of care development process.

The first key output of the system is a baseline suggested Plan of Care, developed from the protocol knowledge imbedded in the model (formatted by Template for consistency), as initially modified by the patient's Medical Profile and defined Treatment Goals Profile. The stakeholders are presented with this initial Plan of Care recommendation.

Next, the baseline Plan of Care is adjusted based upon the patient's Behavior Profile. The Behavior Profile captures relevant personality characteristics, drawn from non-medical indicia, that correspond to how likely it is that a given patient will comply with the recommended Plan of Care.

The Behavior Profile is developed in a manner similar to the Medical Profile (Inference Engine logic). However, the Behavior Profile is developed through the identification and scoring of key behavior-related non-medical indicia; each indicia described in the form of a mathematic expression, and from which an aggregate score is obtained. Personal behavioral characteristics such as the behavior component of depression, addiction propensities, anger management problems, issues with authority, poor coping skills, anti-social tendencies, work history, criminal record and driving record.

This aggregate value will then be applied to the baseline Plan of Care in order to make adjustments to the plan. For example, the Behavior Profile may suggest that a patient will be non-compliant for a given treatment. This being the case, that treatment will may not be incorporated into the Plan of Care document.) The second key output becomes a behavior adjusted Plan of Care.

At this juncture, a payer's or self-insured employer's payment preferences will be overlaid unto the suggested Plan of Care. These payment preferences identify patient-specific covered benefits, as well as those services, procedures, prescription drugs, investigational therapies, or investigational devices that will not be covered. These preferences will be used to highlight the area of the proposed plan that is both inside and outside the patient's current benefit package. The next output is a Behavior-adjusted Plan of Care that highlights covered services and benefits.

Next, stakeholders are presented with “what if” scenarios, and treatment choices or treatment adjustments can be made through a process of negotiation. It is during this phase of the process that the patient's Life Style Choices Profile is applied. This profile is developed in the same manner as the Medical and Behavior Profiles (inference engine logic determining relationships among the key variables. However, the same Life Style Choices indicia will be used for all pain indications). Key indicia include smoking, alcohol consumption, obesity, job choice, activity level, sporting activities, seat belt use and helmet use. The patient's Life Style Choices Profile is described as an aggregate mathematic expression and will be taken into consideration during the final planning process, when negotiating change.

The stakeholder negotiation process is facilitated through modeling software that allows users to alter the scenario by changing one or more indicia or changing a related indicia score to determine how that change will impact the treatment model. For example, the model could determine how treatment would change based upon whether the patient: lost 20 pounds, quit smoking, took an anger management class, started wearing a motor cycle helmet, or attended a coping skills seminar. (A logical end result is that this process may result in the development of a more flexible benefit package.) This ability to model change is provided to the user at all times during the care process.

The negotiation process to finalize the personalized Care Plan next applies Stakeholder Preferences. Preference Profiles are developed for each of stakeholder, including the primary care physician, specialist, patient, payer and employer. (Primary care physicians and specialists are identified from such sources as the patient, the medical record, employer data or payer data.) Each profile captures self-described significant concerns, needs and interests of the stakeholders. Stakeholder preferences are described as mathematic expressions. Examples of preference indicia by stakeholder are described below.

Stakeholder Preferences Profile

| Stakeholder | Preference Indicia |
|---|---|
| Primary Care Physician | Treatment Choices |
| | Pain Indication |
| | Site of Service |
| Specialist | Treatment Choices |
| | Pain Indication |
| | Site of Service |
| Patient | Treatment Cost |
| | Required Compliance |
| | Treatment Duration |
| | Impact of Treatment on Life Style |
| Payer | Treatment Cost |
| | Treatment Effectiveness |
| | Size of Patient Population |
| | Overall Cost Reduction |
| Employer | Cost of Care |
| | Worker Productivity |
| | Patient Compliance |
| | Treatment Effectiveness |

The output generated after this step in the process is a personalized, 24-month or longer, Plan of Care, which is communicated to all stakeholders.

As care proceeds, progress against the plan is closely monitored, and outcomes data is supplies to the stakeholders, in accordance with pre-defined rules that provides the data in a manner required by law and rule, and within the patient's expressed desires for data confidentiality and use. It is anticipated that the patient's desires can be so expressed in a standard written manner, or through electronic signature. It is also expected that the system can de-identify certain data to conform to these requirements.

The Plan of Care is dynamic, in the sense that it is subject to change based upon the input of certain additional data that could trigger such change in accordance with pre-defined rules. Patient-specific indicia are continuously monitored from a variety of sources including the medical record, medical and pharmaceutical claims data, employer records, Workers' Compensation records, electronic Patient Diary submissions, and patient implantable and external device data. Payer coverage limitations and stakeholder preferences are also continuously monitored, along with changes to the Patient Treatment Goals profile. Resulting changes trigger the development and re-distribution of an amended Plan of Care, in accordance with pre-defined parameters established in the modeling software.

Additionally, every time a patient receives a service, drug prescription, or procedure under the system, stakeholders are provided notification (in compliance with pre-defined data confidentiality and security parameters.) This and all other relevant information relating to development and implementation of the Plan of Care is also simultaneously submitted to the Data Mart.

The Plan of Care will also be electronically linked to educational websites that will be provided to patients is a personalized manner according to requirements established in the Plan of Care. Patients will also directly receive educational materials via a variety of communication mediums, as prescribed under the Plan of Care

Information in the Data Mart is protected and appropriately secured, and can be used for a number of anticipated uses in addition to improving the inductive learning capabilities of the system. It will also be used, in compliance with all data confidentiality and security requirements, in the conduct of clinical studies; to assist providers in practice management; to assist payers and employers in actuarially-based forecasting; in utilization and cost forecasting; and in quality-related initiatives.

FIG. 16 shows a block diagram of a chronic pain patient care plan embodiment. The embodiment develops a baseline care plan adjusted for medical profile, treatment goals, behavior profile and stakeholder requirements. The stakeholder categorization preferences are used to negotiate a final care plan.

### Prophetic Patient Examples

The following examples describe two individuals who have previously been diagnosed as chronic pain patients through chronic condition management modeling (also embodied as a computer software product). The examples illustrate how a personalized, dynamic Plan of Care is developed through use of a model.

Patient A is a 42-year old male with a lumbar spine injury diagnosis and associated chronic pain. In addition to his diagnosis, his care management needs have been previously modeled as “high” (utilization and cost).

Several key indicia come into play in developing Patient A's Plan of Care. First, Patient A's Medical Profile indicates that he is considered a failed back patient, because he has had two unsuccessful surgical procedures for his back within the past 36 months. His Medical Profile also establishes a significant pattern of chronic prescription drug use, as well as recent multiple chiropractic procedures. These factors trigger an aggregate Medical Profile score indicating that Patient A will be difficult to treat.

Additionally, Patient A's Behavior-adjusted score indicates that he is at significant risk of non-compliance. First, he has an “addictive personality” profile, evidenced by the fact that he is a heavy smoker (2 packs per day for 20 years) and has a high prescription drug use pattern. Patient A also has a poor work attendance history, and has been twice arrested for “driving under the influence”. All these indicia aggregate to a mathematic expression corresponding with a poor compliance risk.

Finally, Patient A's Lifestyle Choices Profile indicates that he leads a sedentary life style, is a heavy smoker, is in a job classification (trucking industry) associated with high risk, and has a documented history of alcohol abuse. Patient A's Lifestyle Choices Profile leads to a poor aggregate score, and this score will be factored in during the negotiated portion of the Plan of Care development process.

The process for developing a Plan of Care for Patient A proceeds in the following manner. The model produces a 24-month baseline Plan of Care model for Patient A, based upon Patient A's medical condition and disease severity as evidenced by his Medical Profile score and identified treatment goals (wants to be able to resume normal sex life, bowling league activities, and to participate in other physical sporting activities).

With these expressed goals taken into consideration, the baseline Plan of Care suggests implantation of an implantable infusion pump, coupled with an aggressive plan of physical therapy. Additionally, Patient A's insurer covers infusion pumps within established coverage parameters. A written plan is provided to Patient A and his family, as well as to his employer, primary care physician and surgeon.

Patient A meets with his primary care physician to discuss treatment options. During this discussion, the parties discuss Patient A's Behavior Profile, which suggest that he is a poor compliance risk. Both Patient A and his physician agree that an infusion pump is an appropriate therapy. The primary care physician agrees to refer to Patient A's orthopedic surgeon, because it clear from the surgeon's Preferences Profile that he also implants pain devices. However, given Patient A's compliance profile, his physician is concerned with Patient's A's desire to participate in an aggressive physical therapy program, and the parties discuss this issue. Patient A indicates a strong desire to participate in the program, and his physician agrees to the model recommendation.

The software indicates that Payer A's insurer will cover a pump for failed back surgery syndrome, and will pay for 10 weeks of physical therapy at 2 (1 hour) sessions per week. The baseline Plan of Care suggests a 12-week program of 3 (1 hour) sessions per week.

Because Patient A is a poor compliance risk, his payer is reluctant to pay for the extra physical therapy sessions. In addition, Patient A's insurer is concerned with his Lifestyle Choices Profile. The parties agree that Patient A will attend an 8-week smoking secession program that is co-sponsored by Patient A's insurer and employer. If Patient A successfully completes the program it will be fully covered. Additionally Patient A's insurer agrees to pay for the extra physical therapy services, with the caveat that Patient A's treatment outcome is measured and reported at the end of every week, using a validated lumbar spine pain outcome assessment tool. The parties agree.

The model generates an agreed upon Plan of Care. This document is then made available to all stakeholders in writing and/or via the internet.

Patient A's progress against the plan is outstanding over time. He successfully completes the smoking secession program and manages to actually lose 5 pounds due to the vigorous exercises incorporated into his physical rehabilitation program. In 12 weeks from initiation of his personalized Plan of Care, Patient A is ready to return to work. His employer, who has been closely monitoring his progress, supports creative return to work policies that are entailed in the employer's preferences profile. These policies, triggered by Patient A's monitored progress, allow Patient A to return to different job classification within the employer's organization, and further provide for an 8-week retraining program to qualify Patient A for his new position. Additionally, Patient A's employer pays for a customized lumbar spine support chair recommended in the Plan of Pare.

Patient A's progress is continuously monitored, and clinically validated outcome measures are routinely taken and provided to the stakeholders and to the data mart, in a manner consistence with law and regulation and within the privacy and security parameters established by the patient. All relevant data is de-identified as required. Data continues to be submitted by Patient A in the form of electronic Patient Diary data. The data continues to show improvement, although device data matches with patient electronic data submission from Patient Diary triggers a change in device setting for the stimulator. Subsequent data submission indicates that the problem was thus corrected.

Patient C is a 46-year old male, heavy industry laborer, with a lumbar spine injury diagnosis and associated chronic pain. In addition to his diagnosis, his care management needs have been previously modeled as “high” (utilization and cost).

Several key indicia come into play in developing Patient C's Plan of Care. First, Patient C's Medical Profile establishes that he suffers from (self-reported) depression, and has not received treatment for this condition. Follow-up self-report surveys indicate that the condition is worsening (electronically submitted Patient Diary data). In addition, Patient C's self-report pain intensity level is rapidly increasing, and his self-report perception on life quality is rapidly decreasing. Patient C's Medical Profile score indicates that he will be difficult to treat, and analysis of the trend of his scores predict a potentially significant pain episode.

The baseline treatment protocol suggested by the model recommends aggressive treatment of Patient C's depression, and principally seeks to stabilize his condition short term. Once his condition stabilizes the modeled baseline plan suggests testing to establish Patient C's candidacy for back surgery and alternatively testing for interventional treatment option of an implantable spinal cord stimulator or implantable infusion pump system (both of which are covered by the insurer). The software develops a Plan of Care modeling each treatment option. This baseline Plan of Care is distributed to the stakeholders. Since Patient C has hired an attorney to represent him on a Workers' Compensation claim, the attorney is also provided the document.

Patient C and his primary care physician meet to discuss the baseline Plan of Care recommended by the system, taking into account patient treatment goals (reduce and hopefully eliminate feeling of hopelessness, reduce pain level to a more acceptable range of 3, 4 pain intensity) and taking into account Patient C's Medical Profile.

In many respects Patient C appears to be a model patient. However, his Behavior Profile establishes him as a high compliance risk due to his serious depression and measured lack of coping skills. For this reason, Patient C's physician convinces him to aggressively treat his depression, incorporating both the suggested baseline treatment as modeled and adding his own treatment preferences to the plan.

The parties review Patient C's Lifestyle Choices Profile and determine that this Profile is a relative non-factor in further amending the plan, despite the fact that Patient C is in a high-risk job category. However, his job categorization will cause his situation to be more closely monitored for future potential job-related health impacts. (However, Patient C has not worked for 5 months and is not expected to return in the near term.)

Stakeholder Preferences are reviewed, and it is determined that both the payer and employer advocate for an in-patient mental health evaluation at Abbott Northwestern Hospital. This evaluation process is incorporated into the Plan of Care, which is agreed upon by all parties. The plan is generated and distributed to the parties.

Over time, Patient C does not stabilize as modeled, and has had several depression-triggered acute inpatient hospitalization episodes causing his Plan of Care to be re-evaluated. During this intervening timeframe Patient C was evaluated for a surgical procedure and was deemed an excellent candidate (although his providers would prefer if he had a more stable mental health profile.) His care providers and Patient C agree to proceed with the surgical procedure and to simultaneously change his drug treatment regimen for his depression, and a new Plan of Care is prepared and distributed to the stakeholders.

During implementation of the Plan of Care, Patient C's mental health is closely monitored. Mental health data is data that is frequently closely guarded by patients. Knowing this, Patient C and his providers meet to specifically discuss the dissemination of his mental health data. The parties agree to how this information may be shared, and the rules of the system are uniquely amended to account for Patient C's privacy request.

Thus, embodiments of a method and computer software product for identifying individual at risk for chronic pain indication in a population are disclosed to improve the accuracy of identifying potential chronic pain patients, decrease the time required to identify potential chronic pain patient so early intervention can be considered, identify potential chronic pain patients that meet the preference of stakeholders, and many other benefits. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A method for creating a chronic pain patient care plan, comprising:
selecting direct medical indicia associated with chronic pain that serve as independent variables;
selecting indirect medical indicia associated with chronic pain that serve as independent variables;
selecting non-medical indicia associated with chronic pain that serve as independent variables;
selecting a chronic pain indication that serves as a dependent variable;
creating a chronic pain care model using direct medical indicia, indirect medical indicia, non-medical indicia, and chronic pain indication;
applying the chronic pain care model to a chronic pain patient to create a patient mathematical expression; and,
creating a chronic pain patient care plan by comparing each patient mathematical expression to selection objectives.

2. The method as in claim 1 wherein the chronic pain forecasting model comprises
a logic structure to define a logical decision process to operate on the independent variables and to progressively reach greater certainty about the chronic pain patient care plan;
weighted variables to reflect greater relevance of certain direct medical indicia, indirect medical indicia, and non-medical indicia to the chronic pain indication; and,
equations that represent relationships between or among weighted variables to form a chronic pain inference engine.

3. The method as in claim 2 wherein the chronic pain forecasting inference engine comprises,
at least fifty dependent variables;
at least thirty independent variables; and,
at least fifty equations.

4. The method as in claim 2 wherein the logic structure is developed using Chi-Square Automatic Interaction Detection (CHAID) analysis to establish relationships between a dependent variable and independent variables.

5. The method as in claim 2 wherein the logic structure is developed using Classification Adjusted Regression Tree (CART) analysis to establish relationships between the dependent variable and the independent variables.

6. The method as in claim 2 wherein the weighted variables are developed using logistical regression to establish relationships between the dependent variable and independent variables.

7. The method as in claim 2 wherein the weighted variables are developed using discriminate analysis to establish relationships between the dependent variable and independent variables.

8. The method as in claim 2 wherein appropriateness of patient indicia is evaluated using the Hosmer-Lemeshow Goodness of Fit Analysis.

9. The method as in claim 1 wherein the chronic pain patient's care plan is identified with a patient mathematical expression generated by the chronic pain inference engine operating on the patient indicia and the chronic pain indication.

10. The method as in claim 1 wherein the patient indicia are monitored for changes and the patient mathematical expression is updated when patient indicia change.

11. The method as in claim 1 further comprising,
establishing categorization preferences that specify care plan characteristics that are desired to be selected;
calculating the categorization preferences with each chronic pain patient's mathematical expression to identify relationships between the categorization preferences and each potential chronic pain patient's mathematical expression; and,
categorizing care plan characteristics based upon the relationships between the categorization preferences and each chronic pain patient's mathematical expression.

12. The method as in claim 11, further comprising,
considering each chronic pain patient based upon lifestyle choices to adjust categorization.

13. The method as in claim 12 wherein lifestyle choices are selected from the group consisting of smoking, alcohol consumption, obesity, job choice, activity level, sporting activities, seatbelt use, and helmet use.

14. The method as in claim 1 wherein the selection objectives are selected from the group consisting of treatment time period, experimental procedures, invasive procedures, back-to-work date, standard of care, case manager for care, and treatment provider names.

15. The method as in claim 1 wherein the direct medical indicia are related to chronic pain in a known medical manner and recorded by a clinician.

16. The method as in claim 15 wherein the direct medical indicia are independent variables selected from the group consisting of primary diagnosis, associated secondary diagnosis, co-morbidities, drug treatment regimen, telephone consultations with a clinician, trauma episodes, palliative care, rehabilitative care, clinician office visits, emergency room visits, and hospitalizations.

17. The method as in claim 15 wherein the sources for direct medical indicia are selected from the group consisting of claims records, medical records, workers' compensation records, and employer records.

18. The method as in claim 1 wherein indirect medical indicia are a chronic pain co-morbidity that is recorded by a clinician.

19. The method as in claim 18 wherein the indirect medical indicia are independent variables selected from the group consisting of mental health condition, acute respiratory episodes, diabetes, and heart failure.

20. The method as in claim 18 wherein the sources for indirect medical indicia are selected from the group consisting of claims records, medical records, workers' compensation records, employer records, and patient surveys.

21. The method as in claim 1 wherein the non-medical indicia are independent variables selected from the group consisting of pain perception factors, life satisfaction measures, patient support structure, day-time distractions, marital relationship quality, and job satisfaction.

22. The method as in claim 21 wherein the sources for non-medical indicia are selected from the group consisting of medical records, patient surveys, patient self-reports, employer databases, workers' compensation records, medical chart reviews, patient interviews, treating clinician interviews, and family member interviews.

23. The method as in claim 1 wherein the chronic pain indication is selected from the group consisting of Peripheral Neuropathy; Stump Pain; Phantom Pain; Complex Regional Pain Syndrome Type I (Reflex Sympathetic Dystrophy); Complex Regional Pain Syndrome Type II (Causalgia); Central Pain; Rheumatoid Arthritis; Osteoarthritis; Sickle Cell Arthropathy; Stiff Man Syndrome; Osteoporosis; Guillain-Barre Syndrome; Superior Pulmonary Sulcus Syndrome (Pancoast Tumor); Pain of Skeletal Metastatic Disease of the Neck, Arm, or Shoulder Girdle; Carcinoma of Thyroid; Post Herpetic Neuralgia; Syphilis (Tabes Dorsalis and Hypertrophic Pachymeningitis); Primary Tumor of a Vertebral Body; Radicular Pain Attributable to a Prolapsed Cervical Disk; Traumatic Avulsion of Nerve Roots; Primary Tumor of a Vertegral Body; Radicular Pain Attributable to a Thoracic Disk; Chemical Irritation of the Brachial Plexus; Traumatic Avulsion of the Brachial Plexus; Postradiation Pain of the Brachial Plexus; Painful Arms and Moving Fingers; Brachial Neuritis (Brachial Neuropathy, Neuralgic Amyotrophy, Parsonage-Turner Syndrome); Raynaud's Disease; Raynaud's Phenomenon; Frostbite and Cold Injury; Brythema Pernio (Chilblains); Acrocyanosis; Livedo Reticularis; Volkmann's Ischemic Contracture; Thromboangiitis; Intermittent Claudication; Rest Pain; Gangrene Due to Arterial Insufficiency; Other Postinfectious and Segmental Peripheral Neuralgia; Angina Pectoris; Postmastectomy Pain Syndrome (Chronic Noumalignant); Late Postmastectomy Pain or Regional Carcinoma; Segmental or Intercostal Neuralgia; Chronic Pelvic Pain Without Obvious Pathology; Pain from Urinary Tract; Carcinoma of the Bladder; Lumbar Spinal or Radicular Pain after Failed Spinal Surgery; Spinal Stenosis (Cauda Equina Lesion); Pain referred from Abdominal or Pelvic Viscera or Vessels Perceived as Sacral Spinal Pain; Femoral Neuralgia; and, Sciatica Neuralgia.

24. The method as in claim 23 wherein the source for chronic pain indications is the International Association for the Study of Pain (IASP) chronic pain guidelines.

25. The method as in claim 1 wherein the chronic pain patients are selected from the group consisting of payer database, employer database, clinician database, and workers' compensation database.

26. A method for creating a chronic pain patient care, comprising:
accessing a chronic pain care model having direct medical indicia, indirect medical indicia, non-medical indicia, and a chronic pain indication that are arranged logic structure, with weighted variables, and equations representing relationship between or among the variables;
applying the chronic pain care model to a chronic pain patient to create a patient mathematical expression;
creating a chronic pain patient care plan by comparing each patient mathematical expression to selection objectives;
establishing categorization preferences that specify characteristics of the care plan that are desired to be categorized;
calculating the categorization preferences with each chronic pain patient's mathematical expression to identify relationships between the categorization preferences and each chronic pain patient's mathematical expression;
categorizing characteristics of the care plan based upon the relationships between the categorization preferences and each chronic pain patient's mathematical expression; and,
monitoring the chronic pain patient's direct medical indicia, indirect medical indicia, and non-medical indicia for changes and updating the patient's mathematical expression based upon changes to the potential chronic pain patient's direct medical indicia, indirect medical indicia, and non-medical indicia.

27. A computer software product that includes a medium readable by a computer, the medium having stored thereon instructions for creating a chronic pain patient care plan, comprising:
a first set of instructions when executed by the computer, causes the computer access a chronic pain care model having direct medical indicia, indirect medical indicia, non-medical indicia, and a chronic pain indication that are arranged logic structure, with weighted variables, and equations representing relationship between or among the variables;
a second set of instructions when executed by the computer, causes the computer to applying the chronic pain care model to a chronic pain patient to create a patient mathematical expression; and,
a third set of instructions when executed by the computer, cause the computer to create a chronic pain patient care plan by comparing each patient mathematical expression to selection objectives.

28. The computer software product as in claim 27, further comprising,
a fourth set of instruction when executed by the computer, cause the computer to establish categorization preferences that specify characteristic of the chronic pain patient's care plan that are desired to be categorized;
a fifth set of instruction when executed by the computer, cause the computer to calculate the categorization preferences with each chronic pain patient's mathematical expression to identify relationships between the categorization preferences and each chronic pain patient's mathematical expression; and,
a sixth set of instruction when executed by the computer, cause the computer to categorize characteristics of the care plan based upon the relationships between the categorization preferences and each chronic pain patient's mathematical expression.

29. A method for sensitivity analysis of a chronic pain care model, comprising:
comparing the chronic pain patient's care plan with outside treated chronic pain patient data to create a patient error list;
applying an error assessment model to the patient error list to identify the non-corresponding patient indicia that contributed to the errors;
applying a sensitivity analysis model to the non-corresponding patient indicia to identify potential patient indicia changes to improve accuracy of a chronic pain patient medical resources;
selecting at least one patient indicia change from the potential patient indicia changes to apply to the patient indicia; and,
modifying the patient indicia with the at least one selected patient indicia change.

30. The method as in claim 29, further comprising
applying a sensitivity analysis model to the weighted variables to identify potential weighted variable changes to reduce errors in the chronic pain patient's care plan;
selecting at least weighted variable change from the potential weighted variable changes to apply to the weighted variables; and,
modifying weighed variables to reflect greater or lesser relevance of patient indicia to reduce errors in creating the chronic pain patient care plan.
